(19) United States
(12) Patent Application Publication
(10) Pub. No.: US 2020/0048426 A1
(43) Pub. Date: Feb. 13, 2020

(54) INORGANIC TUBULAR-LIKE PARTICLES IN A POLYMER MATRIX

(71) Applicant: NANOTECH INDUSTRIAL SOLUTIONS, INC., Avenel, NJ (US)

(72) Inventor: Anna Kossoy, Rehovot (IL)

(21) Appl. No.: 16/536,860

(22) Filed: Aug. 9, 2019

Related U.S. Application Data
(60) Provisional application No. 62/716,654, filed on Aug. 9, 2018.

(51) Int. Cl. C08K 3/30; C09J 133/08; C09J 11/04; C09J 163/00; C01G 41/00; C09J 127/12; C09J 175/04

(52) U.S. Cl. CPC C08K 3/30; C09J 133/08; C09J 11/04; C09J 163/00; C01P 2004/13; C09J 127/12; C09J 175/04; C08K 2003/3009; C08K 2201/011; C01G 41/00

(57) ABSTRACT

A composite is provided including metal chalcogenide nanotubes as the dispersed phase in a polymeric matrix, in which the polymeric matrix may be a fluoropolymer, urethane (e.g., polyurethane), sulfonic polymer, as well as epoxy and acrylic polymers for adhesive applications, such as pressure sensitive adhesives.

### CROSS REFERENCE TO RELATED APPLICATION

The present invention claims the benefit of U.S. provisional patent application 62/716,654 filed Aug. 9, 2018 the whole contents and disclosure of which is incorporated by reference as is fully set forth herein.

### FIELD OF THE INVENTION

The present disclosure relates to inorganic particles having tubular-like geometry in a polymer matrix.

### BACKGROUND

Polymer, and polymer adhesives, are widely used in numerous fields and industries from aerospace, automotive, construction, electronics, defense, marine, and other related or like fields and industries. In some polymeric applications, it is desirable to have increased elasticity of a base polymeric composition simultaneously increasing the toughness of the base polymeric composition. One means for doing this has been through the use of additives in a composite structure. For example, the additives may provide a dispersed phase, which can be provided by nanomaterials. One disadvantage of nanomaterials as used in a polymeric base composition is that their size can lead to agglomeration of the particles. The agglomerates can lead to increased stress at sites within the polymeric matrix, which provide the site for crack initiation.

### SUMMARY

In one embodiment of the present disclosure, a composite is provided including metal chalcogenide nanotubes as the dispersed phase in a polymeric matrix, in which the polymeric matrix may be a fluoropolymer, urethane (e.g., polyurethane), sulfonic polymer, as well as epoxy and acrylic polymers for adhesive applications, such as pressure sensitive adhesives.

In one embodiment, the composite includes a dispersed phase of an inorganic material having a nanotube or nanolog geometry, in which the dispersed phase is of a metal chalcogenide composition which has a molecular formula MX₂, where M is a metallic element selected from the group consisting of titanium (Ti), vanadium (V), zirconium (Zr), niobium (Nb), molybdenum (Mo), ruthenium (Ru), hafnium (Hf), tantalum (Ta), tungsten (W), rhenium (Re), platinum (Pt) and combinations thereof, and X is a chalcogen element selected from the group consisting of sulfur (S), selenium (Se), tellurium (Te) and combinations thereof. The inorganic material of the metal chalcogenide having the molecular formula MX₂ is uniformly present in the fluoropolymer matrix in an amount of greater than 0.1 wt %.

In one embodiment of the composite composition including the fluoropolymer matrix, in which the dispersed phase, e.g., nanotube and/or nanolog is a multilayered structure, the outer layer of the multi-layered nanotube or multi-layered cylinders of the nanologs comprises at least one sectioned portion. The at least one sectioned portion extends along a direction away from the substantially planar sidewalls that extend along the greatest length of the multilayered nanotube or multilayered nanolog. The at least one sectioned portion at the ends of the multi-layered cylinders extend away from the curvature of the nanotube and/or nanolog structure, and the at least one sectioned portion engaged to remaining section of the outer layer of the multilayered nanotube or multilayered nanolog.

In another embodiment, the composite includes a dispersed phase of an inorganic material having a nanotube or nanolog geometry, in which the dispersed phase is of a metal chalcogenide composition which has a molecular formula MX₂, where M is a metallic element selected from the group consisting of titanium (Ti), vanadium (V), zirconium (Zr), niobium (Nb), molybdenum (Mo), ruthenium (Ru), hafnium (Hf), tantalum (Ta), tungsten (W), rhenium (Re), platinum (Pt) and combinations thereof, and X is a chalcogen element selected from the group consisting of sulfur (S), selenium (Se), tellurium (Te) and combinations thereof. The inorganic material of the metal chalcogenide having the molecular formula MX₂ is uniformly present in the urethane polymer matrix in an amount of greater than 0.1 wt %.

In one embodiment of the composite composition including the urethane polymer matrix, in which the dispersed phase, e.g., nanotube and/or nanolog is a multilayered structure, the outer layer of the multi-layered nanotube or multi-layered cylinders of the nanologs comprises at least one sectioned portion. The at least one sectioned portion extends along a direction away from the substantially planar sidewalls that extend along the greatest length of the multilayered nanotube or multilayered nanolog. The at least one sectioned portion at the ends of the multi-layered cylinders extend away from the curvature nanotube and/or nanolog, and the at least one sectioned portion engaged to remaining section of the outer layer of the multilayered nanotube or multilayered nanolog.

In yet another embodiment, the composite includes a dispersed phase of an inorganic material having a nanotube or nanolog geometry, in which the dispersed phase is of a metal chalcogenide composition which has a molecular formula MX₂, where M is a metallic element selected from the group consisting of titanium (Ti), vanadium (V), zirconium (Zr), niobium (Nb), molybdenum (Mo), ruthenium (Ru), hafnium (Hf), tantalum (Ta), tungsten (W), rhenium (Re), platinum (Pt) and combinations thereof, and X is a chalcogen element selected from the group consisting of sulfur (S), selenium (Se), tellurium (Te) and combinations thereof. The inorganic material of the metal chalcogenide having the molecular formula MX₂ is present in a sulfonic polymer matrix in an amount of greater than 0.1 wt %.

In one embodiment of the composite composition including the sulfonic polymer matrix, in which the dispersed phase, e.g., nanotube and/or nanolog is a multilayered structure, the outer layer of the multi-layered nanotube or multi-layered cylinders of the nanologs comprises at least one sectioned portion. The at least one sectioned portion extends along a direction away from the substantially planar sidewalls that extend along the greatest length of the multilayered nanotube or multilayered nanolog. The at least one sectioned portion at the ends of the multi-layered cylinders extend away from the curvature of the nanotube or nanolog, and the at least one sectioned portion engaged to remaining section of the outer layer of the multilayered nanotube or multilayered nanolog.

In yet an even further embodiment, an adhesive composition includes a dispersed phase of an inorganic material having a nanotube or nanolog geometry, in which the dispersed phase is of a metal chalcogenide composition which has a molecular formula MX₂, where M is a metallic element selected from the group consisting of titanium (Ti), vanadium (V), chromium (Cr), niobium (Nb), molybdenum (Mo), ruthenium (Ru), hafnium (Hf), tantalum (Ta), tungsten (W), rhenium (Re), platinum (Pt) and combinations thereof, and X is a chalcogen element selected from the group consisting of sulfur (S), selenium (Se), tellurium (Te) and combinations thereof, wherein the inorganic material of the metal chalcogenide having the molecular formula MX₂ is present in an epoxy or acrylic based adhesive matrix in an amount of greater than 0.1 wt %.

In one embodiment of the adhesive composition, in which the dispersed phase, e.g., nanotube and/or nanolog is a multilayered structure, the outer layer of the multi-layered nanotube or multi-layered cylinders of the nanologs comprises at least one sectioned portion. The at least one sectioned portion extends along a direction away from the substantially planar sidewalls that extend along the greatest length of the multilayered nanotube or multilayered nanolog. The at least one sectioned portion at the ends of the multi-layered cylinders extend away from the curvature of the multi-layered nanotube and/or nanolog, and the at least one sectioned portion engaged to remaining section of the outer layer of the multilayered nanotube or multilayered nanolog.

In another aspect, a method is provided for simultaneously increasing elongation and toughness of epoxy based adhesives by incorporating nanotubes or nanologs within the epoxy base material. In one embodiments, the method includes functionalizing the metal chalcogenide nanotubes or nanologs to provide a non-agglomerated mixture; and mixing the non-agglomerated mixture of metal chalcogenide nanotubes or nanologs with an epoxy base material to provide mixture of uniformly dispersed metal chalcogenide nanotubes within the epoxy base material. The mixture of non-uniformly dispersed metal chalcogenide nanotubes and/or nanologs in the epoxy based material is then applied to an adhesion surface and cured.

In yet another aspect, a single stage method of forming nanotubes is provided that includes positioning a solid precursor containing a metal chalcogenide and oxygen on a reactor floor which is not permeable to gas in a reaction setup equipped with reactor, and furnace heating the solid precursor in reaction atmosphere consisting of hydrogen (H₂), hydrogen sulfide (H₂S) and nitrogen (N₂). The method further includes maintaining a reaction atmosphere from 1 hour to 4 hours, wherein during the reaction period metal chalcogenide containing nanotubes are formed from the solid precursor having a diameter ranging from 10 nm to 500 nm, and a length up to 20 microns long.

In an even further aspect, a method of forming nanotubes is provide that includes positioning a solid precursor containing a metal chalcogenide and oxygen on a reactor floor that is not permeable to gas in a reaction setup equipped with reactor and furnace; and heating the furnace including the solid precursor to a temperature ranging from 600° C. to 950° C. in an inert atmosphere. The method continues with exchanging the inert atmosphere with a reaction atmosphere that is a gas selected from the group consisting of hydrogen, hydrogen sulfide (H₂S) and nitrogen (N₂). The reaction atmosphere and the inert atmosphere is maintained for a reaction period ranging from 1 hour to 4 hours, wherein during the reaction period metal chalcogenide nanotubes are formed from the solid precursor.

In one embodiment of the present disclosure, a nano structure is provided that includes a multi-layered nanotube and/or nanolog structure comprising a plurality of layers each comprised of an metal chalcogenide composition has a molecular formula of MX₂, where M is a metallic element selected from the group consisting of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg) and combinations thereof, and X is a chalcogen element selected from the group consisting of sulfur (S), selenium (Se), tellurium (Te), oxygen (O) and combinations thereof. The outer layer of the multi-layered nanotube and/or nanolog structure comprises at least one sectioned portion. The at least one sectioned portion extends along a direction away from the substantially planar sidewalls that extend along the greatest length of the multilayered nanotube or multilayered nanolog. The at least one sectioned portion at the ends of the multi-layered cylinders extend away from the curvature of the multi-layered nanotube and/or nanolog, and the at least one sectioned portion engaged to remaining section of the outer layer of the multilayered nanotube or multilayered nanolog.

In another embodiment, the present disclosure provides a lubricant. The lubricant may include a fluid medium; and at least one intercalation compound of a metal chalcogenide having molecular formula MX₂, where M is a metallic element selected from the group consisting of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg) and combinations thereof, and X is a chalcogen element selected from the group consisting of sulfur (S), selenium (Se), tellurium (Te), oxygen (O) and combinations thereof. The intercalation compound has a multi-layered layered nanotube and/or nanolog structure.

In some embodiments, the outer layer of the multi-layered nanotube and/or nanolog structure comprises at least one sectioned portion. The at least one sectioned portion extends along a direction away from the substantially planar sidewalls that extend along the greatest length of the multilayered nanotube or multilayered nanolog. The at least one sectioned portion at the ends of the multi-layered cylinders extend away from the curvature of the multi-layered nanotube and/or nanolog, and the at least one sectioned portion engaged to remaining section of the outer layer of the multilayered nanotube or multilayered nanolog.

### BRIEF DESCRIPTION OF DRAWINGS

The following detailed description, given by way of example and not intended to limit the disclosure solely thereto, will best be appreciated in conjunction with the accompanying drawings, wherein like reference numerals denote like elements and parts, in which:

FIG. 1 is an illustration depicting one embodiment of a metal chalcogenide nanotube, in accordance with the present disclosure.

FIG. 2 is a transmission electron microscope (TEM) image of a metal chalcogenide having a molecular formula MX₂ and a nanotube-like geometry, in accordance with one embodiment of the present disclosure.

FIG. 3 is a second transmission electron microscope (TEM) image of a metal chalcogenide having a molecular formula MX₂ and a nanotube-like geometry, in accordance with one embodiment of the present disclosure.

FIG. 4 is a schematic view illustrating one embodiment of chemical reactor for forming some examples of metal chalcogenide intercalation compounds, in accordance with one embodiment of the present disclosure.

FIG. 5 is a block diagram illustrating one embodiment of an apparatus for forming metal chalcogenide nanotubes, in accordance with one embodiment of the present disclosure.

FIG. 6 is a transmission electron microscope (TEM) image that is representative of a sidewall of a multi-layered nanotube of metal chalcogenide having a molecular formula MX₂ under a stress that exfoliates tribofilm lamellas that fill and re-smoothen damaged surfaces, in accordance with one embodiment of the present disclosure.

FIG. 7 is an illustration depicting a multilayered metal chalcogenide nanotube having an outer layer having at least one sectioned portion extends along a direction away from the substantially planar sidewalls that extend along the greatest length of the multilayered nanotube. The at least one sectioned portion at the ends of the multi-layered cylinders extend away from the curvature of the multi-layered nanotube, and the at least one sectioned portion engaged to remaining section of the outer layer of the multilayered nanotube or multilayered nanolog.

### DETAILED DESCRIPTION

Detailed embodiments of the present disclosure are described herein; however, it is to be understood that the disclosed embodiments are merely illustrative of the compositions, structures and methods of the disclosure that may be embodied in various forms. In addition, each of the examples given in connection with the various embodiments are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the compositions, structures and methods disclosed herein. References in the specification to ‘one embodiment’, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment.

Nanoparticles as the dispersed phase in a composite of a polymeric matrix, such as a polymeric matrix composed of a fluoropolymer, urethane (e.g., polyurethane), sulfonic polymer, as well as epoxy and acrylic polymers, have potential to increase both strength, i.e., toughness, and elasticity of the polymer matrix, simultaneously. For example, tungsten disulfide WS₂ nanotubes, as well as molybdenum disulfide MoS₂, include polar bonds and sulfur termination in the nanoparticles that could promote specific interaction with the polymer and the lack of extended π(pi) systems (i.e., double bonds) leads to much weaker particle to particle interactions when compared to other nanoparticles, such as carbon based nanoparticles, e.g,. carbon nanotubes. In the case of tungsten disulfide (WS₂), the material may function as a semiconductor material with an optical band gap that can be tuned according to the nanotube diameter, doping of the nanotube, alloying of the nanotube, and/or functionalizing the surface of the nanotube. As will be described in greater detail below, the use of the tungsten disulfide nanotube having an adjustable optical band gap can be employed for tuning the adhesives cure reaction.

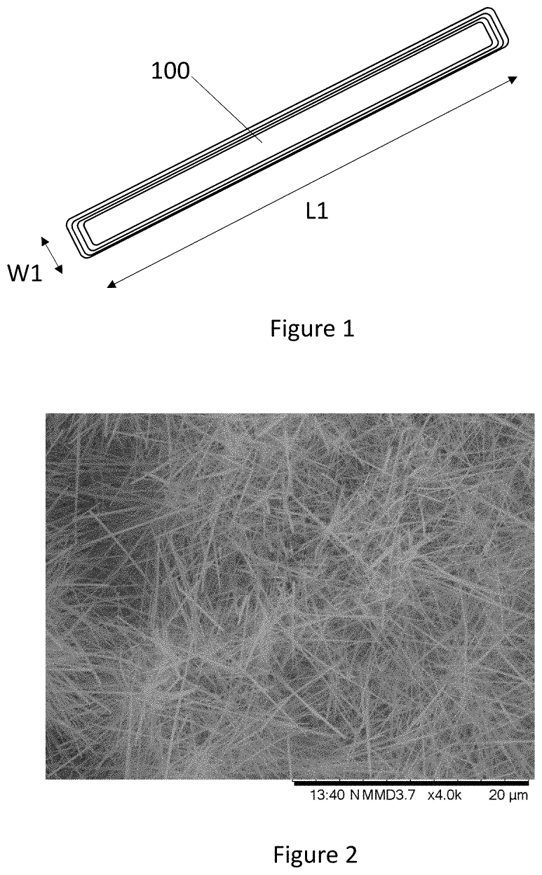

For example, photochemically initiated radical curing of acrylates or cationic curing of epoxides co-initiators can be used for absorption and transfer of the light energy or the photoexcited electrons to the initiator. To meet the latter, a distinct bandgap is preferred, which can be adjusted in the case of WS₂ depending on available light sources, initiators and desired process conditions with respect to the specific adhesives. Furthermore, there is a strong need to detect stresses in adhesive bonds during processing and in service to avoid uncontrolled failure of bonded parts. Interestingly, Raman scattering, optical absorption in the visible and dielectric behavior of WS₂ were shown to be strongly dependent on the applied mechanical stresses. These properties are useful for monitoring the adhesive performance. These are only some aspects and advantages that can be provided by incorporating inorganic nanotubes, such as tungsten disulfide nanotubes and/or molybdenum disulfide nanotubes, with polymeric base materials. Further details and advantages are now described with reference to FIGS. 1-6.

FIGS. 1-3 are to illustrate some embodiments of metal chalcogenide nanotubes, in accordance with the present disclosure. This material provides the dispersed phase of an inorganic material that is present within the polymeric matrix, and as described above provides enhancements in the elongation performance of the polymer, the toughness performance of the polymer and can also facilitate curing of epoxy type polymers, and provide for stress/strain measurements in the polymeric matrix through which the metal chalcogenide nanotube may be uniformly dispersed. The geometry of the nanotubes is tube-like. As used herein, the term “tubular-like geometry” denotes a columnar or cylindrical geometry, in which one axis, i.e., length (L) of the geometry provides for an aspect ratio with the diameter (D)greater than 100:1.

The tubular geometry and the elongated length (L) that provides the aspect ratio with respect to the diameter (D), is illustrated in FIG. 1, which is an illustration of a single multi-wall nanotube composed of a metal chalcogenide material, such as. It is noted that the aspect ratio of 100:1 is relatively short for the nanotubes provided herein. For example, the length (L) vs. diameter (D), i.e., aspect ratio, of the nanotubes that are described herein can range from 100:1 to 150,000:1. The aspect ratio combined with the arcular cross-section of the nanotubes provides that the geometry in some embodiments can be cylindrical. The term “arcular” means that the geometry contains at least one curvature and is closed. This can include substantially circular and elongated cross-sections. In some embodiments, an inorganic material having the metal chalcogenide composition and the tubular-like geometry may be a cage geometry that is hollow at its core and layered at is periphery. In other embodiments, the core may be solid or be amorphous. For example, the inorganic material having the metal chalcogenide composition and the tubular-like geometry may be a single layer or double layered structure or triple layered structure, in which each layer is progressively bigger and contains the previous layers therein. These structures are also referred to in the art as being “nested layer structures”. Further, it is noted that the inorganic metal chalcogenide nanotubes that employed in the present disclosure are not limited to only one wall, two wall or three wall structures. For example, the number of walls in the nanotubes may be equal to 1, 2, 3, 4, 5, 5, 6, 7, 8, 9, 10, 15, 20 and 30, as well as any range of number of walls including one of the aforementioned examples as a lower limit and one of the aforementioned examples as an upper limit of the range.

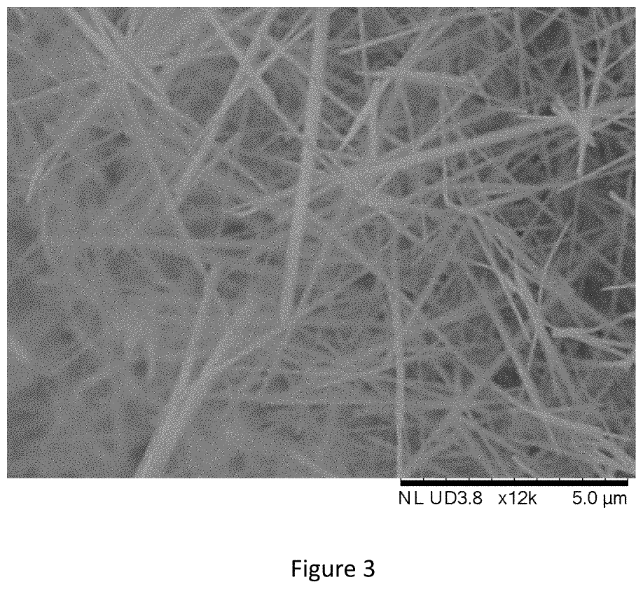

One example of an inorganic material having the metal chalcogenide composition and the tubular-like geometry, which is hereafter referred to an inorganic nanotube and/or metal chalcogenide nanotube, is depicted in FIGS. 2 and 3. FIGS. 2 and 3 depict a transmission electron microscope (TEM) image of an inorganic nanotube/metal chalcogenide nanotube, which can function as an intercalation compound. In another example, the inorganic material having the metal chalcogenide composition and the tubular-like geometry is composed of molybdenum disulfide (MoS₂). It is noted that the inorganic material having the metal chalcogenide composition and the tubular-like geometry that is depicted in FIGS. 1-3 is not limited to only tungsten disulfide (WS₂) and molybdenum disulfide (MoS₂). Inorganic materials having a tubular-like geometry may have any inorganic composition that meets the formula MX₂, where M is a metallic element selected from the group consisting of titanium (Ti), vanadium (V), zirconium (Zr), niobium (Nb), molybdenum (Mo), ruthenium (Ru), hafnium (Hf), tantalum (Ta), tungsten (W), rhenium (Re), platinum (Pt) and combinations thereof, and X is a chalcogen element selected from the group consisting of sulfur (S), selenium (Se), tellurium (Te) and combinations thereof.

The inorganic materials having the metal chalcogenide composition and the tubular-like geometry may have a diameter D, i.e., distance perpendicular to the greatest axis of the tubular-like geometry, ranging from 1 nm to 2 μm. In another embodiment, the inorganic materials having the metal chalcogenide composition and the tubular-like geometry may have a diameter D ranging from 5 nm to 600 nm. In yet another embodiment, the inorganic materials having the metal chalcogenide composition and the tubular-like geometry with a diameter D ranging from 10 nm to 150 nm. The inorganic materials having the metal chalcogenide composition and the tubular-like geometry may have a length L, i.e., greatest axis of the tubular-like geometry that ranges from 1 nm to 100 μm. In another embodiment, the inorganic materials having the metal chalcogenide composition and the tubular-like geometry may have a length L, i.e., greatest axis of the tubular-like geometry, that ranges from 5 nm to 15 μm. In yet another embodiment, the inorganic materials having the metal chalcogenide composition and the tubular-like geometry may have a length L, i.e., greatest axis of the tubular-like geometry, that ranges from 100 nm to 10 μm. The inorganic materials having the metal chalcogenide composition and the tubular-like geometry may have a length L or diameter D that is any value within the above ranges. It is noted that the above dimensions are provided for illustrative purposes only and are not intended to limit the present disclosure.

In some embodiments, the inorganic nanotubes/metal chalcogenide nanotubes, e.g., tungsten disulfide (WS₂) nanotubes, may be synthesized by the high temperature conversion of WO₃ powder into WS₂ nanotubes with hydrogen sulfide (H₂S) in a reducing atmosphere. In one example, high-temperature growth, e.g., at temperatures ranging from 650° C. to 900° C., was found to occur in a two-steps process in which W₁₈O₄₉ nanowhiskers were grown first. Subsequently, the nanowhiskers where sulfurized. For this reaction, W₁₈O₄₉ nanowhiskers were reacted with H₂S in a reducing atmosphere. It was observed that in a first stage, the nanowiskers are converted on their surface into few layers of WS₂, which coat the entire oxide core, conformably. These layers protect the oxide nanowhiskers and prevent their mutual reaction into macroscopic WS₂ platelets. Subsequently, the H₂S gas diffuses slowly into the oxide core, converting it progressively into WS₂ by a layer-by-layer type of reaction. After few hours annealing a powder consisting of purely INT (inorganic nanotube)-WS₂ nanoparticles phase are obtained.

The inorganic materials having the metal chalcogenide composition, e.g., WS₂, and the tubular-like geometry may be produced via sulfidization of tungsten oxide nanoparticles in reduction atmosphere in fluidized bed reactor. The inorganic materials having the metal chalcogenide composition and the tubular-like geometry may be formed in accordance with at least one of the methods disclosed in U.S. Pat. Nos. 6,217,843, 6,710,020, 6,841,142, 7,018,606 and 7,641,886, 7,524,481 which are each incorporated herein in their entirety. It is noted that the methods disclosed in the aforementioned patents are only some examples of methods that are suitable for forming the inorganic materials having the metal chalcogenide composition and the tubular-like geometry. Any method may be employed for forming the above-described inorganic materials having the metal chalcogenide composition, so long as the compound formed has a tubular-like geometry.

In yet other embodiments, the metal chalcogenide nanotubes, i.e., metal chalcogenide having a tubular-like geometry, can be formed using a one-step method, i.e., single stage, to synthesize WS₂ INTs. It is noted that the single stage method described herein is suitable for forming any of the nanotube compositions described within this disclosure.

The single stage forming method may begin with positioning a solid precursor containing a metal chalcogenide and oxygen on a reactor floor that is not permeable to gas in a reaction setup equipped with a reactor. In some embodiments the precursor may be placed directly on the reactor floor. The methods described for the single stage process do not employ a fluidized bed reactor. In some embodiments, when forming tungsten disulfide nanotubes, the solid precursor can be WO₃, WO₃₋ₓ (0≤x<0.3), ammonium paratungstate, ammonium metatungstate and combinations thereof. In some embodiments, the precursor powder can be placed in quartz crucible and placed inside a furnace heated to reaction temperature, e.g., a temperature ranging from 750° C. to 900° C., in an inert atmosphere. The inert atmosphere can prevent oxygen deficient phases from untimely reduction. The inert atmosphere can be optional and can be the use of the inert atmosphere can be eliminated by employing an interlock, in which the precursor only enters the reaction atmosphere when the reaction temperature is reached.

In the embodiments employing an inert atmosphere, the atmosphere can then be exchanged with a reaction gas that includes hydrogen (H₂), hydrogen sulfide (H₂S) and nitrogen (N₂). The reaction at this stage of the process flow includes reduction accompanied by particle elongathion and silfidization processes.

The reaction can continue for a reaction period ranging from 0.5 hour to 4 hours. The reaction atmosphere is passed through the reactor in a flow direction from into the furnace to out of the furnace at a directional flow rate ranging from 10 sccm to 100,000 sccm.

To end the reaction the atmosphere can be exchanged to an inert and the reaction product can be cooled to room temperature, e.g., 20° C. to 25° C. In some embodiments, the entirety of the reactions from heating the solid precursor to maintaining the reaction atmosphere to provide the chalcogenide containing nanotubes is in a single reaction chamber, and may therefore be referred to as being in a single stage, which means that in order to take out elongated nanoparticles of WS₂ at the end of the process, the reactor should be opened only once. During the reaction period, metal chalcogenide containing nanotubes, e.g., tungsten disulfide (WS₂) nanotubes and/or molybdenum disulfide (MoS₂) nanotubes, are formed from the solid precursor having a diameter ranging from 10 nm to 500 nm, and a length up to 20 microns long.

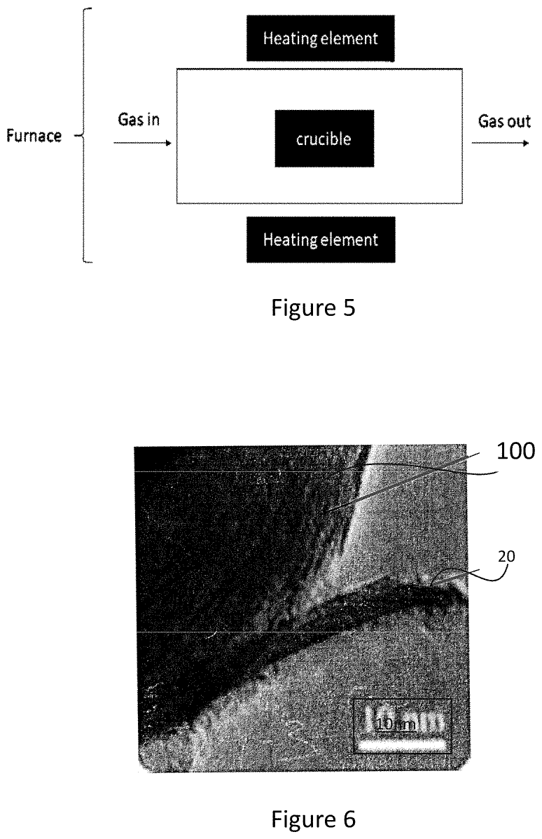

In some embodiments, the crucible can be inserted into the furnace with inert atmosphere that has already been heated to a reaction temperature ranging from 750° C. to 900° C. The atmosphere then exchanged to reaction gas which comprises of H₂, H₂S and N₂. The reaction goes from 0.5 to 4 hours. To end the reaction the atmosphere is exchanged to inert and is cooled to room temperature. The reaction setup is depicted in FIG. 5.

In some embodiments, the resulting product produced from the reaction set up depicted in FIG. 5 consists of WS₂ nanotubes that are 10-500 nm in diameter, and up to 20 microns long. The nanotubes could be hollow or stuffed with residual WO₃₋ₓ, i.e., having a core of residual WO₃₋ₓ. The product may consist of the mixture of stuffed and hollow nanotubes. In some other embodiments, the product may consist of the nanotubes as above (stuffed, hollow or mixture of thereof) and up to 50% of WS₂ platelets.

It is noted that the nanotubes may be doped. For example, in the case of tungsten disulfide (WS₂), the material may function as a semiconductor material with an optical band gap that can be tuned. In addition to tuning the band gap by selecting the dimensions of the nanotubes and/or functionalizing the nanotubes, the bang gap may be adjusted by doping of the nanotube as well as position of the Fermi level and the conductivity of the nanoparticles. The doping of the nanotube to adjust the materials band gap can be employed for which can be employed for photochemical reactions within media that embeds nanotubes as a dispersed phase distributed, e.g., uniformly, throughout the polymeric matrix, e.g., epoxy matrix.

It is also noted that the doping can provide that the exterior surfaces of the inorganic nanotubes (INTs) composed of tungsten disulfide (WS₂) or molybdenum disulfide (MoS₂) can produce a charged exterior surface, e.g., negatively charged, in which the exterior surface charges provides for a repulsive force between inorganic nanotubes that facilitates their dispersion in a non-agglomerated manner.

The doping/alloying that can be introduced to the metal chalcogenide using at least 5 different metal atoms, like Nb, Ta, Re, Mo, Ti and others in different concentrations. Mixtures of metal oxides can also be used as precursors for doping purposes. For example, doping of INT-MoS₂ nanoparticles may be conducted with minute amounts, e.g., less than 500 ppm, of rhenium (Re) and niobium (Nb). The control of the doping level provides for modulating the position of the Fermi level and the conductivity of the nanoparticles, which can be helpful in providing band gap adjustment, which can be employed for photochemical reactions within embedding media. Furthermore, the Re-doped nanoparticles are negatively charged on their surface and consequently exhibit self-repulsion. This provides that INT-MoS₂ that are doped, e.g., with rhenium (Re) and/or niobium (Nb), form stable suspensions. Doping can be at levels greater than 1 at. %. Substitutional doping can be applied to both the metal (W, Mo) site or on the non-metal (sulfur) site of the inorganic nanotube (INT). Doping and alloying, can be done by in-situ reaction during the synthesis of the inorganic nanotubes (INT), or doping can be also done posteriori. In posterior type doping, the undoped nanoparticles are synthesized and subsequently doped by an extrinsic atom by temperature driven diffusion into the host lattice. Mixtures of metal chlorides can be used as precursor for doping the inorganic nanotubes (INTs).

In some embodiments, the dispersed phase is provided by nanologs, which can be substituted for the nanotubes, or be employed simultaneously within the dispersed phase with the nanotubes. Nanologs are particles that look like a cluster of cylindrical bodies. Nanologs are further described in PCT/US17/16408, which is incorporated herein in its entirety. Some details regarding nanologs are described in the following paragraphs.

In one embodiment of the present disclosure, a nano structure is provided that includes a cluster of cylindrical bodies. Each of the cylindrical bodies in the cluster is substantially aligned with one another so that their lengths are substantially parallel. The composition of the cylindrical bodies for the nanologs may comprise tungsten (W) and sulfur (S), and each of the cylindrical bodies has a geometry with at least one dimension that is in the nanoscale. Each cluster of cylindrical bodies may have a width dimension ranging from 0.3 microns to 5.0 microns (in some examples ranging from 0.3 microns to 3.0 microns) and a length greater than 5.0 microns. In some embodiments, the cylindrical bodies are composed of tungsten disulfide (WS₂).

In some embodiments, each of the cylindrical bodies has a hollow core across their entire length. In some examples, an oxide layer can be present between the tungsten and sulfur containing body and the hollow core. In another embodiment, the cylindrical body has a solid core in at least one portion of the cylindrical body along its length. The solid core can be composed of an oxide containing composition. In some examples, the solid core may extend along an entire length of the cylindrical body. In other embodiments, the cylindrical bodies can include a hollow core that alternates with a solid oxide core along the length of the cylindrical body.

In some embodiments, each cluster of cylindrical bodies contains between 2 and 200 cylindrical bodies. In some examples, each of the cylindrical bodies has a width dimension ranging from 10 nm to 100 nm, and each of the cylindrical bodies may have a length greater than 5 microns. In some embodiments, each cluster of cylindrical bodies has a width ranging from 0.2 microns to 1 micron, and a length ranging from 5 microns to 100 microns.

In another embodiment, a nanostructure is provided that includes a cluster of cylindrical bodies, in which each cylindrical body has a hollow core. Each of the cylindrical bodies in the cluster is substantially aligned with one another so that their lengths are substantially parallel. The composition of the cylindrical bodies comprise tungsten (W) and sulfur (S), and each of the cylindrical bodies has a geometry with at least one dimension that is in the nanoscale. Each cluster of cylindrical bodies may have a width dimension ranging from 0.2 microns to 2.0 microns, and a length greater than 5.0 microns. In some embodiments, the cylindrical bodies are composed of tungsten disulfide (WS₂).

In some embodiments, each cluster of cylindrical bodies having the hollow core contains between 2 and 200 cylindrical bodies. In some examples, each of the cylindrical bodies has a width dimension ranging from 10 nm to 100 nm, and each of the cylindrical bodies may have a length greater than 5 microns. In some embodiments, each of said cluster of cylindrical bodies has a width ranging from 0.2 microns to 1 micron, and a length ranging from 5 microns to 100 microns.

In another embodiment, a nanostructure provided consists of outer shell of closed or partly closed crystalline WS₂ layers and interior of crystalline folds of WS₂ and with crystalline regions of WO₃₋ₓ (0<x<0.3). Proportions between sulfide and oxide regions could vary between particles and depending on preparation conditions such as duration of initial synthesis and subsequent annealing if applied.

The method for forming the nanologs may begin with reduction of a particle size of tungsten oxide powder to produce a precursor material having a reduced particle size of less than 2 microns. The precursor material is then heated to a reaction temperature in an inert atmosphere. Once the reaction temperature is reached, the atmosphere is exchanged to contain hydrogen sulfide to provide reduction and sulfidization reactions with the precursor material. Following reaction and sulfidization of the precursor material at the reaction temperature, the reactant structure is cooled and separated into a powder containing clusters of cylindrical bodies. The clusters of cylindrical bodies being composed of tungsten (W) and sulfur (S), wherein each of the cylindrical bodies has a geometry with at least one dimension that is in the nanoscale. Each cluster of cylindrical bodies may have a width dimension ranging from 0.2 microns to 5.0 microns (in some examples a width ranging from 0.3 to 2.0 microns), and a length greater than 5.0 microns.

In one embodiment, reducing the particle size comprises grinding coarse WO₃ to fine size so that 50% of the powder will be below 1 μm. In some embodiments, the amount that the particle size is reduced is selected to impact the final dimension for the clusters of cylindrical bodies, as the starting particle size of the precursor material can impact the final dimension of the clusters.

In some embodiments, heating the precursor material to the reaction temperature includes increases a temperature of the chamber from ambient to a reaction temperature ranging from 750° C. to 950° C. while streaming a nitrogen gas (N₂) atmosphere through the chamber at substantially atmospheric pressure, e.g., slightly higher than atmospheric pressure.

In some embodiments, the step of introducing hydrogen sulfide containing gas into the chamber after the reaction temperature has been reached comprises exchanging the nitrogen gas atmosphere with an atmosphere comprising 30% to 50% hydrogen sulfide (H₂S) gas, and 30% to 50% hydrogen (H₂) gas. In one example, the hydrogen sulfide containing gas into the chamber comprises a mixture of N₂/H₂/H₂S with ratio 1:2:2. The hydrogen sulfide containing gas may be reacted with the precursor material for at least one hour.

In some embodiments, the time period for introducing hydrogen sulfide containing gas to react with the precursor material is selected to provide an oxide core within the cylindrical bodies, or to provide a hollow core within the cylindrical bodies. The time period for producing the hollow core is greater than a time period for creating the solid core. In one example, the time period for producing the solid core is greater than 1 hour and less than 6 hours. The time for producing the hollow core is typically greater than 5 hours. In one embodiment, the time period for producing the hollow core ranges from 6 hours to 10 hours.

In some embodiments, after producing the sulfided reactant structure, the method further comprises flowing nitrogen gas (N₂) through the chamber to end the reduction and sulfidization reactions.

Following their production, the inorganic nanotubes (INTs) and/or nanologs, such as metal chalcogenide nanotubes and/or nanologs, e.g., tungsten disulfide (WS₂) and/or molybdenum disulfide (MoS₂), can be functionalized for incorporation within a polymeric matrix. This can include functionalizing the surface of the inorganic nanotubes (INTs). Inorganic nanotubes, such as metal chalcogenide nanotubes, have advantages in comparison to carbon nanotubes (CNTs), because while CNTs easily agglomerate, INTs have a much smaller tendency to agglomerate. The lower incidence of agglomeration in INTs makes them more convenient to work with.

Agglomeration in nanoparticles can occur during their synthesis, as well as upon dispersion in a media, such as a solution media or during mixing with the base composition of a composite material. In some instances, it may be preferable to avoid agglomeration in the formation of the nanoparticles, as opposed to dispersing agglomerated nanoparticles, because in some instances dispersion methods can impact the integrity of the nanoparticles themselves.

Surface active compounds can be used and surface modification of the nanoparticles, e.g., nanotubes and/or nanologs, can be carried out to avoid agglomeration, and to de-agglomerate nanoparticles that have already agglomerated prior to mixing with the polymeric matrix in forming the composite material.

Surface functionalization of the inorganic nanotubes and/or nanologs, such as metal chalcogenide nanotubes and/or nanologs, e.g., tungsten disulfide (WS₂) and/or molybdenum disulfide (MoS₂), may include the application of silane based coupling agents, including: amino silanes, epoxy silanes, alkyl silanes and acryloxy silanes. The silanes can be used for functionalizing inorganic nanotubes, such as metal chalcogenide nanotubes, e.g., tungsten disulfide (WS₂) and/or molybdenum disulfide (MoS₂), for integration in composites with the epoxy and acrylate resins. These functionalized inorganic nanotubes that are employed in the dispersed phase of a matrix of an epoxy and/or acrylate resin may provide a composite utilized as an adhesive. Functionalization of the inorganic nanotubes using the aforementioned coupling agents is not only used for integrating inorganic nanotubes with polymer matrixes of epoxy and acrylate resins. For example, the aforementioned functionalization may be applied to inorganic nanotubes that are employed as the dispersed phase in polymeric matrix compositions including fluoropolymer, urethane (e.g., polyurethane), sulfonic polymer, and combinations thereof.

In other examples, functionalization may be provided by surface functionalization of the inorganic nanotubes (INT) that can include silanization, mild surface oxidation and plasma treatment. In addition, “soft” (non-covalent) chemical modifiers, like polyethylene glycol (PEG), polyethyleneimine (PEI) and surfactants like CTAB and Triton X can be applied to the inorganic nanotubes to provide for dispersion and non-agglomerated mixtures of the inorganic nanotubes (INT) as the dispersed phase in a matrix of a polymer composition selected from the group consisting of fluoropolymers, urethanes (e.g., polyurethanes), sulfonic polymers, as well as epoxy and acrylic polymers.

In some embodiments, surface functionalization of the inorganic nanotubes and/or nanologs, such as metal chalcogenide nanotubes and/or nanologs, e.g., tungsten disulfide (WS₂) and/or molybdenum disulfide (MoS₂), may include the application of a compound comprising a at least one dithiophosphate group to the inorganic nanotubes and/or nanologs. The compound comprising a dithiophosphate group may be referred to as “dithiophosphate”. In some examples, the dithiophosphate can be selected from the ammonium dithiophosphates, the amine dithiophosphates, the ester dithiophosphates and the metal dithiophosphates, alone or in a mixture.

In an embodiment of the invention, the dithiophosphate is selected from the ammonium dithiophosphates of formula (I):

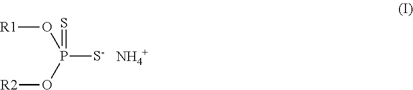

in which R1 and R2 represent, independently of one another, a hydrocarbon-containing group, optionally substituted, comprising from 1 to 30 carbon atoms.

In a one embodiment, R1 and R2 represent, independently of one another, a hydrocarbon-containing group, optionally substituted, comprising from 2 to 24 carbon atoms, and in some embodiments from 3 to 18 carbon atoms. In yet other embodiments, the R1 and R2 represent, independently from one another, a hydrocarbon group comprising from 5 to 12 carbon atoms. In another embodiment, R1 and R2 represent, independently of one another, an unsubstituted hydrocarbon-containing group, and said hydrocarbon-containing group can be an alkyl, alkenyl, alkynyl, phenyl or benzyl group. In another embodiment, R1 and R2 represent, independently of one another, a linear or branched alkyl hydrocarbon-containing group, more preferentially a linear alkyl hydrocarbon-containing group. In yet another embodiment, R1 and R2 represent, independently of one another, a hydrocarbon-containing group optionally substituted by at least one oxygen, nitrogen, sulphur and/or phosphorus atom, preferably by at least one oxygen atom. As examples of ammonium dithiophosphate, the ammonium dimethyldithiophosphates, the ammonium diethyldithiophosphates and the ammonium dibutyldithiophosphates can be mentioned.

In another embodiment, the dithiophosphate is selected from the amine dithiophosphates of general formula (II):

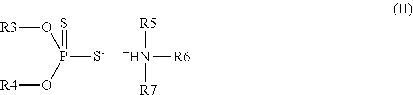

in which: R3 and R4 represent, independently of one another, a hydrocarbon-containing group, optionally substituted, comprising from 1 to 30 carbon atoms. R5, R6 and R7 represent, independently of one another, a hydrogen atom or a hydrocarbon-containing group with 1 to 30 carbon atoms, it being understood that at least one of the R5, R6 and R7 groups does not represent a hydrogen atom.

In yet another embodiment, R3 and R4 represent, independently of one another, a hydrocarbon-containing group, optionally substituted, comprising from 2 to 24 carbon atoms. In yet another embodiment, R3 and R4 represent, independently of one another, from 3 to 18 carbon atoms, and in some examples from 5 to 12 carbon atoms. In another embodiment, R3 and R4 represent, independently of one another, an unsubstituted hydrocarbon-containing group, and said hydrocarbon-containing group can be an alkyl, alkenyl, alkynyl, phenyl or benzyl group. In an even further embodiment, R3 and R4 represent, independently of one another, a linear or branched alkyl hydrocarbon-containing group, more preferentially a linear alkyl hydrocarbon-containing group. In another embodiment, R3 and R4 represent, independently of one another, a hydrocarbon-containing group optionally substituted by at least one oxygen, nitrogen, sulphur and/or phosphorus atom, preferably by at least one oxygen atom. In yet another embodiment, R5, R6 and R7 represent, independently of one another, a hydrocarbon-containing group comprising from 2 to 24 carbon atoms, more preferentially from 3 to 18 carbon atoms, advantageously from 5 to 12 carbon atoms.

In yet another embodiment, the dithiophosphate is selected from the ester dithiophosphates of general formula (III):

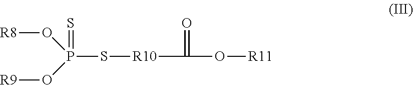

in which:

R8 and R9 represent, independently of one another, a hydrocarbon-containing group, optionally substituted, comprising from 1 to 30 carbon atoms, R10 and R11 represent, independently of one another, a hydrocarbon-containing group comprising from 1 to 18 carbon atoms.

In one embodiment, R8 and R9 represent, independently of one another, a hydrocarbon-containing group, optionally substituted, comprising from 2 to 24 carbon atoms, in one example from 3 to 18 carbon atoms, and in yet another example from 5 to 12 carbon atoms. In another embodiment, R8 and R9 represent, independently of one another, an unsubstituted hydrocarbon-containing group, and said hydrocarbon-containing group can be an alkyl, alkenyl, alkynyl, phenyl or benzyl group. In another embodiment, R8 and R9 represent, independently of one another, a linear or branched alkyl hydrocarbon-containing group, more preferentially a linear alkyl hydrocarbon-containing group.

In another embodiment, R8 and R9 represent, independently of one another, a hydrocarbon-containing group optionally substituted by at least one oxygen, nitrogen, sulphur and/or phosphorus atom, preferably by at least one oxygen atom. In another preferred embodiment of the invention, R8 and R9 represent, independently of one another, a hydrocarbon-containing group comprising from 2 to 6 carbon atoms. In another embodiment, R10 and R11 represent, independently of one another, a hydrocarbon-containing group comprising from 2 to 6 carbon atoms.

In another embodiment, the dithiophosphate is selected from the metal dithiophosphates of general formula (IV):

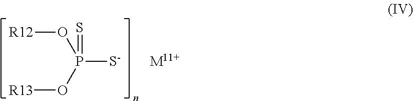

in which:

R12 represents a linear or branched, saturated or unsaturated, substituted or unsubstituted alkyl group comprising from 1 to 30 carbon atoms; R13 represents a linear or branched, saturated or unsaturated, substituted or unsubstituted alkyl group comprising from 1 to 30 carbon atoms; M represents a metal cation, preferably a Zn²⁺ cation; n represents the valency of the metal cation.

In another embodiment, the metal is selected from the group constituted by zinc, aluminium, copper, iron, mercury, silver, cadmium, tin, lead, antimony, bismuth, thallium, chromium, molybdenum, cobalt, nickel, tungsten, sodium, calcium, magnesium, manganese and arsenic. Some examples of metals suitable for this composition include zinc, molybdenum, antimony, preferably zinc and molybdenum. In one example, the metal is zinc. Mixtures of metals can be used. The metal dithiophosphates can be neutral, as exemplified in formula (IV), or basic when a stoichiometric excess of metal is present.

In one embodiment, R12 and R13 represent, independently of one another, a hydrocarbon-containing group, optionally substituted, comprising from 2 to 24 carbon atoms, more preferentially from 3 to 18 carbon atoms, advantageously from 5 to 12 carbon atoms. In another preferred embodiment of the invention, R12 and R13 represent, independently of one another, an unsubstituted hydrocarbon-containing group, and said hydrocarbon-containing group can be an alkyl, alkenyl, alkynyl, phenyl or benzyl group. In another preferred embodiment of the invention, R12 and R13 represent, independently of one another, a linear or branched alkyl hydrocarbon-containing group, more preferentially a linear alkyl hydrocarbon-containing group. In another preferred embodiment of the invention, R12 and R13 represent, independently of one another, a hydrocarbon-containing group optionally substituted by at least one oxygen, nitrogen, sulphur and/or phosphorus atom, preferably by at least one oxygen atom.

Advantageously, the dithiophosphate according to the invention is a zinc dithiophosphate of formula (IV-a) or of formula (IV-b):

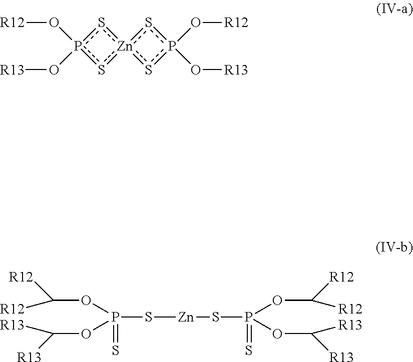

in which R12 and R13 are as defined above.

In another embodiment, the dispersant can be selected from the compounds comprising at least one succinimide group, the polyolefins, the olefin copolymers (OCP), the copolymers comprising at least one styrene unit, the polyacrylates or their derivatives. By derivatives, is meant any compound comprising at least one group or a polymer chain as defined above. Advantageously, the dispersant according to the invention is selected from the compounds comprising at least one succinimide group.

In one embodiment, the dispersant can be selected from the compounds comprising at least one substituted succinimide group or the compounds comprising at least two substituted succinimide groups, the succinimide groups being linked at their vertex bearing a nitrogen atom by a polyamine group. A substituted succinimide group is a succinimide group in which at least one of the carbon-containing vertices of which is substituted with a hydrocarbon-containing group comprising from 8 to 400 carbon atoms. In one embodiment, the dispersant is selected from the polyisobutylene succinimide-polyamines. The dispersant can be a substituted succinimide of formula (I) or a substituted succinimide of formula (II):

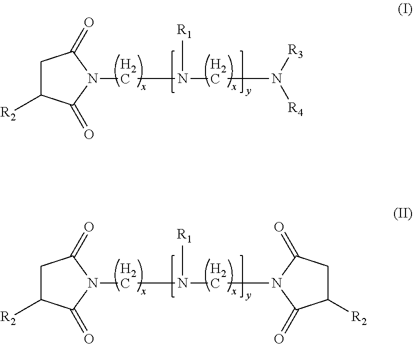

in which:

x represents an integer ranging from 1 to 10, preferably 2, 3, 4, 5 or 6;

y represents an integer ranging from 2 to 10;

R₁ represents a hydrogen atom, a linear or branched alkyl group comprising from 2 to 20 carbon atoms, a heteroalkyl group comprising from 2 to 20 carbon atoms and at least one heteroatom selected from the group formed by O, N and S, a hydroxyalkyl group comprising from 2 to 20 carbon atoms or a —(CH₂)ₓ—O—(CH₂)ₓ—OH group;

R₂ represents a linear or branched alkyl group comprising from 8 to 400 carbon atoms, preferably from 50 to 200 carbon atoms, an aryl group comprising from 8 to 400 carbon atoms, preferably from 50 to 200 carbon atoms, a linear or branched arylalkyl group comprising from 8 to 400 carbon atoms, preferably from 50 to 200 carbon atoms or a linear or branched alkylaryl group comprising from 8 to 400 carbon atoms, preferably from 50 to 200 carbon atoms; and

R₃ and R₄, identical or different, represent independently a hydrogen atom, a linear or branched alkyl group comprising from 1 to 25 carbon atoms, an alkoxy group comprising from 1 to 12 carbon atoms, an alkylene group comprising from 2 to 6 carbon atoms, a hydroxylated alkylene group comprising from 2 to 12 carbon atoms or an aminated alkylene group comprising from 2 to 12 carbon atoms.

The dispersant may be a substituted succinimide of formula (I) or a substituted succinimide of formula (II) in which R₂ represents a polyisobutylene group. The dispersant may be a substituted succinimide of formula (II) in which R₂ represents a polyisobutylene group. The dispersant may be a substituted succinimide of formula (II) in which:

R₁ represents a —(CH₂)ₓ—O—(CH₂)ₓ—OH group,

R₂ represents a polyisobutylene group,

x represents 2, and

y represents 5.

In some embodiments, the dispersant of succinimide has a weight-average molecular weight ranging from 2000 to 15000 Daltons, preferably ranging from 2500 to 10000 Daltons, advantageously from 3000 to 7000 Daltons. In some embodiments, the dispersant also has, moreover, a number-average molecular weight greater than or equal to 1000 Daltons, preferably ranging from 1000 to 5000 Daltons, in one example from 1800 to 3500 Daltons, and in yet another example from 1800 to 3000 Daltons.

In some embodiments, surface functionalization for the surface of the inorganic nanotube and/or nanolog particles/structures having the molecular formula MX₂ may be provided by functionalizing agents that include silanes, thiols, ionic, anionic, cationic, nonionic surfactants, amine based dispersant and surfactants, succinimide groups, fatty acids, acrylic polymers, copolymers, polymers, monomers and combinations thereof.

In some embodiments, the functionalizing agents can be described as comprising a headgroup (a part that interacts primarily with the surface of the inorganic nanotubes and/or nanologs may having the molecular formula MX₂) and a tailgroup (a part that interacts with the solvent, i.e., fluid medium). Useful headgroups include those that comprise alkoxy, hydroxyl, halo, thiol, silanol, amino, ammonium, phosphate, phosphonate, phosphonic acid, phosphinate, phosphinic acid, phosphine oxide, sulfate, sulfonate, sulfonic acid, sulfinate, carboxylate, carboxylic acid, carbonate, boronate, stannate, hydroxamic acid, and/or like moieties. Multiple headgroups can extend from the same tailgroup, as in the case of 2-dodecylsuccinic acid and (1-aminooctyl) phosphonic acid. Useful hydrophobic and/or hydrophilic tailgroups include those that comprise single or multiple alkyl, aryl, cycloalkyl, cycloalkenyl, haloalkyl, oligo-ethylene glycol, oligo-ethyleneimine, dialkyl ether, dialkyl thioether, aminoalkyl, and/or like moieties. Multiple tailgroups can extend from the same headgroup, as in the case of trioctylphosphine oxide.

Following functionalization, the non-functionalized or functionalized inorganic nanotubes and/or nanologs may be dispersed and distributed in the polymeric matrix in the concentration range of 0.5 wt. % to 5 wt. %. It is noted that this range only provides one example of the concentration of the functionalized inorganic nanoparticles, e.g. nanotubes and/or nanologs, in a polymer matrix. It is not intended that the present disclosure be limited to only this example. In other example, the functionalized inorganic nanotubes may be present in amounts that are equal to 0.5 wt. %, 1 wt. %, 1.5 wt. %, 2.0 wt. %, 2. 5 wt. %, 3.0 wt. %, 3.5 wt. %, 4.0 wt. %, 4.5 wt. %, 5 wt. %, 5.5 wt. %, 6.0 wt. %, 6.5 wt. %, 7.0 wt. %, 8 wt. %, 9 wt. % and 10 wt. %, and any range of concentrations including a lower limit provided by one of the aforementioned examples, and an upper limited provided by one of the aforementioned examples.

In one embodiment, a composite is provided having a dispersed phase of the inorganic material of a metal chalcogenide composition with the tubular-like geometry, e.g., tungsten disulfide (WS₂) and/or molybdenum disulfide (MoS₂) nanotubes and/or nanologs, which is present in a polymeric matrix. A composite is a material composed of two or more distinct phases, e.g., matrix phase and dispersed phase, and having bulk properties different from those of any of the constituents by themselves. As used herein, the term “matrix phase” denotes the phase of the composite that is present in a majority of the composite, and contains the dispersed phase, and shares a load with it. In the present case, the matrix phase may be provided by a polymer. As used herein, the term “dispersed phase” denotes a second phase (or phases) that is embedded in the matrix phase of the composite. The dispersed phase is uniformly distributed throughout the entire matrix and is non-agglomerated.

The matrix phase is composed of a polymer composition. Polymers have a linear or branched structure, with anionic groups distributed along the polymeric chain, optionally present also in the chain end groups.

In one embodiment, the polymeric material that provides the matrix for the composite is a fluoropolymer. A fluoropolymer is a fluorocarbon-based polymer with multiple strong carbon-fluorine bonds. Examples of some embodiments of fluoropolymers that may be employed as the matrix of the composite described herein may include PVF (polyvinylfluoride), PVDF (polyvinylidene fluoride), PTFE (polytetrafluoroethylene), PCTFE (polychlorotrifluoroethylene), PFA, MFA (perfluoroalkoxy polymer), FEP (fluorinated ethylene-propylene), ETFE (polyethylenetetrafluoroethylene), ECTFE (polyethylenechlorotrifluoroethylene), FFPM/FFKM (Perfluorinated Elastomer [Perfluoroelastomer]), FPM/FKM (Fluorocarbon [Chlorotrifluoroethylenevinylidene fluoride]), FEPM (Fluoroelastomer [Tetrafluoroethylene-Propylene]), PFPE (Perfluoropolyether), PFSA (Perfluorosulfonic acid), Perfluoropolyoxetane and combinations thereof.

In one embodiment, the polymer composition that provides the matrix is a fluoropolymer hybrid organic/inorganic composite comprising inorganic domains, the hybrid being obtained by reaction between:

1) at least one fluoropolymer comprising recurring units derived from at least one (meth)acrylic monomer [monomer (MA)] of formula:

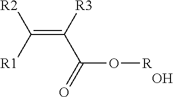

wherein each of R1, R2, R3, equal or different from each other, is independently a hydrogen atom or a C1-C3 hydrocarbon group, and ROH is a hydrogen atom or a C1-C5 hydrocarbon moiety comprising at least one hydroxyl group [polymer (F)]; and

2) at least one metal compound [compound (M)] of formula:

X₄₋ₘAYₘ

wherein m is an integer from 1 to 4, and, according to certain embodiments, from 1 to 3, A is a metal selected from the group consisting of Si, Ti and Zr, Y is a hydrolysable group, X is a hydrocarbon group, optionally comprising one or more functional groups, wherein the inorganic domains are grafted to the polymer (F) through reaction of at least a fraction of the ROH groups of the monomer (MA) with at least a fraction of compound (M).

It is noted that the above examples are only some examples flouropolymers that may be used for the matrix phase of the composite including a dispersed phase of inorganic nanotubes and/or nanologs, e.g., tungsten disulfide (WS₂) and/or molybdenum disulfide (MoS₂). Other fluoropolymer compositions have also been contemplated, such as fluoropolymers formed from monomers selected from the group consisting of Perfluorocycloalkene (PFCA), Ethylene (Ethane) (E), Vinyl fluoride (fluoroethylene) (VF1), Vinylidene fluoride (1,1-difluoroethylene) (VDF or VF2), Tetrafluoroethylene (TFE), Chlorotrifluoroethylene (CTFE), Propylene (P), Hexafluoropropylene (HFP), Perfluoropropylvinylether (PPVE), Perfluoromethylvinylether (PMVE) and combinations thereof.

For example, the fluoropolymer that provides the matrix composition may be composed of fluorinated co-monomers that are selected from —C3-C8 perfluoroolefins; —C2-C8 hydrogenated fluoroolefins, selected from vinyl fluoride (VF), vinylidene fluoride (VDF), trifluoroethylene, CH2=CH-Rf0 perfluoroalkylethylene wherein Rf0 is a C1-C6 perfluoroalkyl; —C2-C6 chloro- and/or bromo- and/or iodo-fluoroolefins; CF2=CFORf0 (per)fluoroalkylvinylethers (PAVE), wherein Rf0 is a C1-C6 (per)fluoroalkyl; CF2=CFOXO (per)fluorooxyalkylvinylethers, wherein X0 is a C1-C12 alkyl; or a C1-C12 oxyalkyl; or a C1-C12 (per)fluorooxyalkyl having one or more ether groups; fluorodioxoles; perfluorodioxoles; and combinations thereof.

In yet another embodiment, the fluoropolymer that provides the matrix composition may be composed of (per)fluoropolymers, preferably PTFE (aka Teflon), still more preferably bistretched PTFE.

In yet another example, the polymer that provides the matrix composition can be a linear semi-crystalline copolymer that includes recurring units derived from vinylidene fluoride (VDF) monomer and at least one hydrophilic (meth)acrylic monomer (MA) of formula:

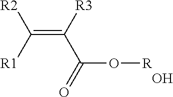

wherein each of R1, R2, R3, equal or different from each other, is independently a hydrogen atom or a C₁-C₃ hydrocarbon group, and R_{0H} is a hydrogen or a C₁-C₅ hydrocarbon moiety comprising at least one hydroxyl group. In one example, the polymer that provides the matrix composition includes from 0.05 to 10% by moles of recurring units derived from the hydrophilic (meth)acrylic monomer (MA) and being characterized by a fraction of randomly distributed units (MA) of at least 40%.

In one aspect of the present disclosure, the polymeric material that provides the matrix for the composite is a sulfonic polymer. One example of a sulfonic polymer that is suitable for a polymeric composition that can provide the matrix for the composite materials described herein includes a blend of a polyphenylene and a poly(aryl ether sulfone), wherein the polyphenylene is a polyphenylene copolymer consisting of structural units derived from 60-95 mole % p-dichlorobenzophenone and 40-5 mole % m-dichlorobenzene and the poly(aryl ether sulfone) consists of structural units of formula:

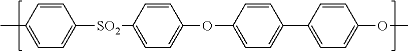

wherein the wt./wt. ratio of the polyphenylene to the poly(aryl ether sulfone) is 5:95-20:80.

In yet another aspect of the present disclosure, the polymeric material that provides the matrix for the composite is a urethane containing composition, such as a polyurethane containing composition. Polyurethane (PUR and PU) is a polymer composed of organic units joined by carbamate (urethane) links. Polyurethane polymers are traditionally and most commonly formed by reacting a di- or poly-isocyanate with a polyol. Both the isocyanates and polyols used to make polyurethanes contain, on average, two or more functional groups per molecule.

One example of a polyurethane composition that can be employed as the matrix for the dispersed nanotubes and/or nanologs of metal chalcogenides compositions in accordance with the present disclosure can include polyurethanes-urea based on perfluoropolyethers including ionizable groups; pendant groups along the polymeric chain backbone having the following structure:

—R^{I}—Si(OR^{II})ₙ(OH)₃₋ₙ

wherein: R^{I} is alkylene from 1 to 10 carbon atoms, preferably from 1 to 5 carbon atoms, still more preferably from 2 to 4 carbon atoms; R^{II} is a linear or branched alkyl group from 1 to 4, preferably from 1 to 3 carbon atoms; and n is an integer from 0 to 3. In some embodiments the aforementioned polyurethane composition may include units that are derived from the following monomers identified below as (per)fluoropolyether diols, diisocyanates, diols, diamines, as follows:

1) (per)fluoropolyether diols having a number average molecular weight from 400 to 5,000, preferably from 800 to 2,500. In some embodiments, the (per)fluoropolyether diols may be present in the polyurethane composition in an amount ranging from 50 wt. % to 85 wt. %. In yet some examples, the (per)fluoropolyether diols are present in the polyurethane composition in an amount ranging from 55 wt. % to 75 wt. %.

2) diisocyanates selected from one or more of the following:

OCN—R—NCO

wherein R is a bivalent radical selected from the following: C2-C12 aliphatic; C6-C18 cycloaliphatic or alkylen-cycloaliphatic, wherein optionally the cycloaliphatic ring can be substituted with one or more C1-C3 alkyl groups, or R contains two cyloaliphatic rings, each containing one of the NCO groups indicated in (IA), said rings joined together by a C1-C6 alkylene chain; C6-C18 aromatic, wherein the aromatic ring can be substituted with one or more C1-C3 alkyl groups, or R contains two aromatic rings, each containing one of the NCO groups indicated in (IA), said rings joined with each other by a C1-C6 alkylene chain. In some embodiments, the diisocyanates may be present in the polyurethane composition in an amount ranging from 10 wt. % to 40 wt. %, and in some examples may be present in an amount ranging from 10% to 30%.

3) diols having an ionizable function, selected from the following:

a) diols having a carboxylic function, of the following general formula:

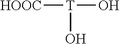

where T is a linear or branched C2-C20, preferably C2-C10, trivalent aliphatic radical, and the two hdyroxyls linked to T can replace also two different aliphatic chains of the trivalent radical, and they are not on the same carbon atom.

b) diols comprising an amine function, having formula:

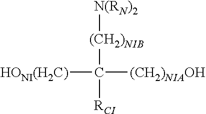

where R_{N} is a linear or branched C1-C6, preferably C1-C4 alkyl; R_{CI} is H or C1-C4 alkyl, N_{I} is an integer and ranges from 1 to 4, N_{IA} is an integer and ranges from 0 to 4, and N_{IB} is an integer and ranges from 1 to 4.

c) diols with amine group in the chain, having formula:

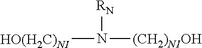

wherein R_{N} is a linear or branched C1-C6; and NI is an integer and ranges from 1 to 4. The aforementioned examples of dioles, i.e., dioles a), b), c), may be present in the aforementioned polyurethane composition in a wt. percent in an amount as great as 3% to 10%. In some examples, the dioles may be present as a monomer unit in the polyurethane composition in an amount ranging from 3 wt. % to 7 wt. %.

4) diamines containing in the molecule one silicon atom, having formula:

(R_{D})NH—R⁰—NH—R^{I}—Si(OR^{II})₃

Where R_{D} is hydrogen or C1-C3 alkyl; R⁰, equal to or different from R^{I}, or has the same meaning as R^{I}. R^{I} is alkylene from 1 to 10 carbon atoms, preferably from 1 to 5 carbon atoms, still more preferably from 2 to 4 carbon atoms. R^{II} is a linear or branched alkyl group from 1 to 4. In some embodiments, diamines as a monomer present in the polyurethane composition may be present in an wt. % ranging from 1% to 12%. In some embodiments, diamines as a monomer present in the polyurethane composition may be present in an wt. % ranging from 4% to 10%.

In addition, to the aforementioned monomers, the aforementioned polyurethane composition may include optionally chain extenders, selected from C1-C6 aliphatic diols, for example diethylenglycol; C3-C10 cycloaliphatic, such as cyclohexyldimethanol, C6-C12 aromatic, hydroquinone bis(2-hydroxyethylether); C2-C6 aliphatic diamines, hydrazine; and combinations thereof. In some embodiments, the optional chain extenders can be present in the aforementioned polyurethane composition in an amount as great as 12 wt. %. In some examples, the optionally chain extenders may be present in a wt. % ranging from 1% to 7%.

In yet another aspect of the present disclosure, the polymeric material that provides the matrix for the composite is an epoxy or acrylic based polymer. Acrylate monomers used to form acrylate polymers are based on the structure of acrylic acid, which consists of a vinyl group and a carboxylic acid terminus. Typical acrylate monomers are derivatives of acrylic acid, such as methyl methacrylate, in which one vinyl hydrogen and the carboxylic acid hydrogen are both replaced by methyl groups, and acrylonitrile in which the carboxylic acid group is replaced by the related nitrile group. Some examples of acrylate monomers include methyl acrylate, ethyl acrylate, 2-chloroethyl vinyl ether, 2-ethylhexyl acrylate, hydroxyethyl methacrylate, butyl acrylate, butyl methacrylate, trimethylolpropane triacrylate (TMPTA) and combinations thereof.

Epoxy resins, also known as polyepoxides are a class of reactive prepolymers and polymers which contain epoxide groups. Epoxy resins may be reacted (cross-linked) either with themselves through catalytic homopolymerisation, or with a wide range of co-reactants including polyfunctional amines, acids (and acid anhydrides), phenols, alcohols and thiols. These co-reactants are often referred to as hardeners or curatives, and the cross-linking reaction is commonly referred to as curing. Epoxy compositions that are suitable for use with the present disclosure may include bisphenol A epoxy resin, bisphenol F epoxy resin, novolac epoxy resin, aliphatic epoxy resin, glycidylamine epoxy resin and combinations thereof.

The epoxy or acrylic polymer compositions within the scope of the present disclosure may be applicable for adhesive applications, such as pressure sensitive applications.

In one embodiment, the polymeric material may be a terpolymer pressure sensitive adhesive of A, B and C monomers, where A is a hydrophobic monomeric acrylic acid ester of a non-tertiary alcohol, the alcohol having from 4 to about 14 carbon atoms; B is at least one polar monomer copolymerizable with the A monomer having hydroxyl, carboxylic, sulfonic or phosphonic functionality, the amount by weight of B monomer being about 2 to 30% of the total weight of all monomers in the terpolymer; and C is a hydrophilic macromolecular monomer of the formula X—Y—Z wherein X is a vinyl group copolymerizable with the A and B monomers, Y is a divalent linking group, and Z is a monovalent polymeric moiety comprising a polyether essentially unreactive under free radical initiated copolymerization conditions, the amount by weight of C monomer being about 5 to 30% of the total weight of all monomers in the terpolymer; and (2) at least one carbonylamido group-containing polymer.

Examples of suitable monomers for use as the A monomer include the esters of acrylic acid or methacrylic acid with non-tertiary alcohols such as 1-butanol, 2-butanol, 1-pentanol, 2-pentanol, 3-pentanol, 2-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctyl alcohol, 2-ethyl-1-hexanol, 1-decanol, 1-dodecanol, 1-tridecanol, 1-tetradecanol and the like. The preferred A monomer is the ester of acrylic acid with isooctyl alcohol.

The polar B monomers suitable for use in accordance with this disclosure are those having hydroxyl, carboxylic, sulfonic, or phosphonic acid functionality. Representative examples are 2-hydroxyethylacrylate, 2-hydroxyethylmethacrylate, hydroxypropylacrylate, acrylic acid, methacrylic acid, itaconic acid, maleic acid, fumaric acid, vinyl benzoic acid, 2-carboxyethylacrylate, 2-sulfoethylmethacrylate, and 4-vinyl phenyl phosphonic acid. Preferred B monomers are acrylic acid, methacrylic acid, 2-carboxyethylacrylate, itaconic acid, 2-hydroxyethylacrylate, hydroxypropylacrylate, and 2-sulfoethylmethacrylate. The amount by weight of B monomer preferably does not exceed about 30% of the total weight of all monomers, such that excessive firmness of the adhesive is avoided. Incorporation of B monomer to the extent of about 10% to about 15% by weight is most preferred and provides for compatible blends possessing good cohesive and adhesive properties.

Monomer C of the pressure-sensitive adhesive is a hydrophilic macromolecular monomer which has a vinyl group copolymerizable with the A and B monomers. By the use of the term “hydrophilic” in connection with the C monomer is meant that the C monomer has substantial affinity for water. It is preferred that the C monomer contain only one vinyl group copolymerizable with the A and B monomers. Monomer C is a hydrophilic macromolecular monomer containing a plurality of hydrophilic sites which impart the required hydrophilicity to the monomer. Monomer C may be represented by the general formula:

X—Y—Z

wherein X is a vinyl group copolymerizable with the A and B monomers, Y is a divalent linking group, and Z is a monovalent polymeric moiety, i.e., containing two or more monomer units, comprising a polyether essentially unreactive under the free radical initiated, copolymerizing conditions employed to form the pressure-sensitive adhesive terpolymer. In one embodiment, the X group of the C monomer is of the following general formula:

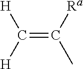

wherein R^{a} is a hydrogen atom or a methyl group.

In one embodiment, the Y group of the C monomer is a divalent carbonyl group having the general formula:

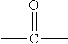

In one embodiment, the Z moiety of the C monomer is a monovalent polyether of the general formula:

—W—OR^{b}

wherein R^{b} is hydrogen, lower alkyl, phenyl, or substituted phenyl; and W is a divalent poly(lower alkylene oxide) group containing 2 to about 250 repeating alkoxy units and selected from the group consisting of a poly(ethylene oxide) radical, a poly(propylene oxide) radical, a radical of a copolymer of ethylene oxide and propylene oxide, and a poly(tetramethylene oxide) radical.

In some embodiment, the at least one carbonylamido group-containing polymers selected from the group consisting of: a poly(alkyloxazoline) having a molecular weight above about 1,000; a poly(N-vinyllactam); a copolymer of a N-vinyl lactam; a polymer of a mono- or dialkyl substituted acrylamide; a copolymer of a mono or dialkyl acrylamide; and a mixture of two or more of the foregoing. The carbonylamido group-containing polymer being present in sufficient amounts to provide an adhesive mass with a tensile strength of at least 400 KPa and maximum elongation of about 1,000 percent. These values being further increased by incorporation of the dispersed phase of the inorganic nanotubes and/or nanotubes composed of a metal chalcogenide composition, such as molybdenum disulfide and/or tungsten disulfide.

In yet another example, the polymer that provides the matrix through which the dispersed phase of inorganic nanotubes and/or nanologs is present, e.g., dispersed phase of tungsten disulfide and/or molybdenum disulfide nanotubes, is an acrylic copolymer based adhesive, e.g., pressure sensitive adhesive. For example, the pressure sensitive adhesive may include 60-99% alkyl acrylate esther, 1-40% monoethylenically unsaturated polar copolymerizible monomer, and 0.3-7% petroleum wax. The alkyl acrylate esther may be substituted with monomers, such as isooctyl acrylate, 2-ethyl hexyl acrylate, isononyl acrylate, decyl acrylate, dodecyl acrylate, butyl acrylate, hexyl acrylate, and combinations thereof. The monoethylenically unsaturated polar copolymerizible monomer may be substituted with other strongly polar monomers, such as acrylic acid, acrylamide, itaconic acid, hydroxyalkyl acrylates, or substituted acrylamides or moderately polar monomers such as N-vinyl-2-pyrrolidone, N-vinyl caprolactam, and acrylonitrile. Where strongly polar monomers are used, they preferably comprise from about 5 parts to about 15 parts of the acrylic copolymer. Where moderately polar monomers are used, they preferably comprise from about 20 to about 40 parts of the acrylic copolymer. In some embodiments, the petroleum based wax is provided by a paraffin wax.

In an even further embodiment, the polymer that provides the matrix through which the dispersed phase of inorganic nanotubes and/or nanologs is present, e.g., dispersed phase of tungsten disulfide and/or molybdenum disulfide nanotubes and/or nanologs, is an epoxy adhesive, e.g., pressure sensitive adhesive. In one example, the adhesive includes (a) about 30% to about 80% by weight of a photopolymerizable monomeric or prepolymeric syrup containing an acrylic acid ester of a nontertiary alcohol, and a moderately polar copolymerizable monomer; (b) from about 20% to about 60% by weight of an epoxy resin or a mixture of epoxy resins containing no photopolymerizable groups; (c) from about 0.5% to about 10% by weight of a heat-activatable hardener for the epoxy resin; (d) from about 0.01% to about 5% of a photoinitiator; and (e) from 0% to about 5% of a photocrosslinking agent.

In one example, the acrylic ester, e.g., acrylic acid ester of the photopolymerizable monomeric or prepolymeric syrup, is a monofunctional acrylic ester of a non-tertiary alcohol, having from about 4 to about 12 carbon atoms in the alcohol moiety. Included in this class of acrylic esters are butyl acrylate, hexyl acrylate, 2-ethylhexyl acrylate, octyl acrylate, isooctyl acrylate, decyl acrylate and dodecyl acrylate. The alkyl acrylate comprises from about 50 to about 95 parts of the prepolymer resin blend, and preferably from about 55 to about 80 parts.

In one example, the copolymerizable moderately polar monomers of the photopolymerizable monomeric or prepolymeric syrup can be selected from the group consisting of nitrogen containing monomers, such as N-vinyl pyrrolidone, N-vinyl caprolactam, N-vinyl piperidine and acrylonitrile. The moderately polar comonomer comprises from about 50 to about 5 parts of the prepolymer resin blend, and preferably from about 45 to about 20 parts.

Useful epoxy resins for use with the above photopolymerizable monomeric or prepolymeric syrup may be selected from the group of compounds that contain at least two epoxy groups per molecule. The epoxy resin can be either liquid or a semi-liquid at room temperature for handling purposes, although a mixture of a liquid and solid resin may be employed if the resulting mixture is liquid. Representative examples include phenolic epoxy resins, bisphenol epoxy resins, and halogenated bisphenol epoxy resins. In one example, the epoxy resin is a diglycidyl ether of a bisphenol-A, formed by reaction of bisphenol-A with epichlorohydrin.

The hardener may be any type. In one example, the hardener is an amine type hardener that is selected from the group consisting of dicyandiamide, polyamine salts and combinations thereof. The photoinitiator having the formula 2,2-dimethoxy-1,2-diphenylethane-1-one. The crosslinking agent may be a multifunctional acrylate, such as 1,6-hexanediol diacrylate.

In some embodiments, the adhesive systems are suitable for highly automated processes in the electronic, optoelectronic, medical and the automotive industry, and therefore they need to be very quickly curable. In some embodiments, the epoxy resins are fast photo-curing adhesives with a polymer design for durable, mechanically highly stressed bonded parts, flexible and strong, low temperature curing electrically conducting adhesives as well as dual curing adhesives with a very low shrinkage on cure, low CTE and high toughness.

The composites disclosed herein, i.e., polymeric matrix including dispersed phase of metal chalcogenide inorganic nanotubes (INTs) and/or polymeric matrix including a dispersed phase of metal chalcogenide inorganic nanologs, may be formed by mixing the metal chalcogenide inorganic nanotubes (INTs) and/or nanolog, e.g., tungsten disulfide (WS₂) and/or molybdenum disulfide (MoS₂), with the polymerization reactants are part of the polymerization process, which may include step polymerization, radical chain polymerization, emulsion polymerization, ionic chain polymerization, chain polymerization, ring open polymerization, and combinations thereof. In some embodiments, because the metal chalcogenide inorganic nanotubes (INTs) are functionalized, as described above, the metal chalcogenide inorganic nanotubes (INTs), i.e., tungsten disulfide (WS₂) and/or molybdenum disulfide (MoS₂), may be introduced as a dispersion of a majority of non-agglomerated nanoparticles. The dispersion may be entirely non-agglomerated. Further, because of the surface functionalization, which can include a charged surface, e.g., negative or positively charged surface, of the inorganic metal chalcogenide, the dispersion remains non-agglomerated, e.g., entirely non-agglomerated, within the matrix of the polymer throughout the polymerization process, and in the final composite product.

In some embodiments, the composite structure may include a second dispersed phase in addition to the first dispersed phase of the metal chalcogenide inorganic nanotubes (INTs), e.g., tungsten disulfide INTs and/or molybdenum disulfide INTs. The second dispersed phase can include inorganic fullerenes, e.g., tungsten disulfide inorganic fullerenes (WS₂—IF) and/or molybdenum disulfide inorganic fullerenes (MoS₂); and/or carbon containing materials, such as carbon nanotubes, e.g., single wall carbon nanotubes (CNT) or multi-wall carbon nanotubes (SWNT), or graphitic materials, such as carbon black (CB), graphitic fibers, diamond like carbon (DLC). The second dispersed phase of carbon containing materials could be used in polymer matrices for reinforcement or in order to obtain desired physical, chemical or mechanical properties.

In some embodiments, the second dispersed phase may be present in the polymer matrix in an amount ranging from 0.1 wt. % to 60 wt. %. In another embodiment, the second dispersed phase may be present in the polymer matrix in an amount ranging from 0. 1 wt. % to 40 wt. %. In yet another embodiment, the second dispersed phase may be present in the polymer matrix in an amount ranging from 0.1 wt % to 30 wt. %.

In some embodiments, the composite material may further include a filler, such as an inorganic filler. Examples of inorganic fillers that are suitable for use with the methods and structures of the present disclosure include fillers such as talc, calcium carbonate, wollastonite, clay, zinc oxide, titanium oxide and dioxide, alumina trihydrate, barium sulfate, calcium sulfate, carbon blacks, metal fibers, boron fibers, ceramic fibers, polymeric fibers, kaolin, glass, ceramic, carbon or polymeric microspheres, silica, mica, glass fiber, and/or carbon fiber.

The filler component, containing one or more of the above-listed fillers or other suitable fillers, may be present in an amount of up to about 50 percent, more preferably from about 2 percent to about 20 percent of the entire composition.

The above composite compositions may be formed into structural components using extrusion. Extrusion is only one way to form a composite product in accordance with the present disclosure. For example, composite structures may be formed using molding methods. In one example, a composite structure including a polymeric matrix and a dispersed phase of the inorganic material having the metal chalcogenide composition, e.g., tungsten disulfide (WS₂), and having a nanolog and/or tubular-like, e.g., nanotube, geometry may be formed using injection molding. In injection molding, a composite precursor including a polymeric matrix and a dispersed phase of the inorganic material having the metal chalcogenide composition, e.g., tungsten disulfide (WS₂), and having a tubular-like geometry is melted and forced into a mold cavity. The mold cavity has the geometry for the composite structure. Once cooled, the melted composite precursor solidifies in the form of the geometry defined by the mold, and the mold can be removed. In another embodiment, the composite structure may be formed using blow molding. Blow molding is like injection molding except that hot liquid precursor composite material pours out of a barrel vertically in a molten tube. The mold closes on it and forces it outward to conform to the inside shape of the mold. When it is cooled, a hollow geometry is formed for the composite structure. In another embodiment, the composite product of the polymer matrix and the dispersed phase of the inorganic material having the metal chalcogenide composition, e.g., tungsten disulfide (WS₂), and having a tubular-like geometry may be formed using compression molding. In this type of plastic molding, a slug of hard plastic, i.e., slug of solidified composite precursor including the polymeric matrix and a dispersed phase of the inorganic material having the metal chalcogenide composition, e.g., tungsten disulfide (WS₂), and having a tubular-like geometry, is pressed between two heated mold halves. Compression molding usually uses vertical presses instead of the horizontal presses used for injection and blow molding. The parts of the composite material that are formed are then air-cooled. In other examples, composite parts may be formed using rotational molding, structural foam molding, thermoforming, film insert molding, gas assist molding and combinations thereof.

In some embodiments, the metal chalcogenide nanologs can function as an intercalation material having lubricating properties. In some embodiments, continuous friction applied to a metal chalcogenide, e.g., tungsten disulfide (WS₂) or molybdenum disulfide (MoS₂), having a nanolog like geometry will exfoliate the outer layers of material 11 wherein the exfoliating outer layers create a tribofilm layer (also referred to as exfoliated layer). A “tribofilm” is defined as a thin solid film generated as a consequence of sliding contact, which is adhered on a contacting, i.e., frictional, surface, but has different chemical composition, structure and tribological behavior than the contacting surface. The exfoliated nano-particle layers accumulate in wear crevices in the surfaces that the tribofilm layer comes in contact with, creating a continuous super-lubricating tribofilm layer. The exfoliated tribofilm layers from the metal chalcogenide of the coating may be referred to as lamellas. The lamellas orient parallel to the deposition surface in the direction of the frictional motion. Even between highly loaded stationary surfaces the lamellar structure is able to prevent contact. Therefore, in some embodiments, the composite structures disclosed herein may induce lubricating properties on surfaces that they come in contact with the composite structures, wherein the composite structures contain the metal chalcogenide having the nanotube geometry, e.g., tungsten disulfide, that can exfoliate outer layers of the layered structure to provide tribofilms.

In some embodiments, the tribofilm layer that may be exfoliated from the layered nanolog geometry metal chalcogenide, e.g., WS₂, of the composite provides a damping effect to absorb shock between the surface that the tribofilm layer is formed on a second surface that the tribofilm layer contacts. The particles, being closed-cage, absorb pressure. Additionally, in the direction of motion the lamellas of the tribofilm layer easily shear over each other resulting in a low friction. The lubricating tribofilm layer repairs wear damage, prevents further wear, reduces the coefficient of friction and reduces the local temperature.

For example, a composite of a polymeric matrix containing a dispersed phase of metal chalcogenide with a nanolog geometry, e.g., tungsten disulfide WS₂, can create a tribofilm of exfoliated material of metal chalcogenide, e.g., tungsten disulfide WS₂, with a frictional surface that is contacting the composite structure. Further, exfoliated material of metal chalcogenide, e.g., tungsten disulfide WS₂, with a nanolog geometry from the composite structure can create a fresh tribofilm on the composite itself. Consequently, the coefficient of friction for the composite structure is constantly low.

Another advantage of the composite of the polymeric matrix containing the dispersed phase of metal chalcogenide with the nanotube and/or nanolog geometry, e.g., tungsten disulfide WS₂, is the shock wave resistance of the nanostructures. For example, the shock-wave resistance of WS₂ nanotubes has been studied and compared to that of carbon nanotubes, in which it has been determined that WS₂ nanotubes are capable of withstanding shear stress caused by shock waves of up to 21 GPa. Under similar shock conditions, WS₂ tubes are more stable than carbon nanotubes, the latter being transformed into a diamond phase. In some embodiments, the supershock-absorbing ability of the IF-WS₂ enables them to survive pressures up to 25 GPa accompanied with concurrent temperatures of up to 1000° C. without any significant structural degradation or phase change. IF-WS₂ are stable in air at temperatures higher than 400° C.

Curing reaction of adhesives can be tuned with help of metal chalcogenide nanoparticles, e.g., nanotubes and/or nanologs. In the case of the photochemically initiated radical curing of acrylates or cationic curing of epoxides co-initiators can be used for absorption and transfer of the light energy or the photoexcited electrons to the initiator. To meet the latter, need a distinct bandgap is required which can be adjusted in the case of WS₂ depending on available light sources, initiators and desired process conditions with respect to the specific adhesives. In applications including epoxies and polymeric compositions for adhesives, the inorganic metal chalcogenide nanotubes, e.g., tungsten disulfide (WS₂) or molybdenum disulfide (MoS₂), can be employed to facilitate photochemically initiated radical curing of acrylates or cationic curing of epoxides co-initiators. A distinct bandgap is preferred for these applications, which can be adjusted in the case of metal chalcogenide nanotubes, such as tungsten disulfide WS₂ and/or molybdenum disulfide, depending on available light sources, initiators and desired process conditions with respect to the specific adhesives. It is also noted that the doping of the inorganic nanotubes, e.g., inorganic nanotubes (INTs) composed of tungsten disulfide (WS₂) or molybdenum disulfide (MoS₂), can adjust the band gap of the material, which can be employed to cure polymeric materials having epoxy based compositions, and/or adhesive applications. The doping of the nanotube to adjust the materials band gap can be employed for adjusting the cure reaction for polymeric composites, e.g., epoxies that include the doped nanotubes as a dispersed phase distributed, e.g., uniformly, throughout the polymeric matrix, e.g., epoxy matrix.

FIG. 6 is a transmission electron microscope (TEM) image that is representative of a sidewall of a multi-layered nanotube 100 of metal chalcogenide having a molecular formula MX₂ under a stress that exfoliates tribofilm lamellas that fill and re-smoothen damaged surfaces.

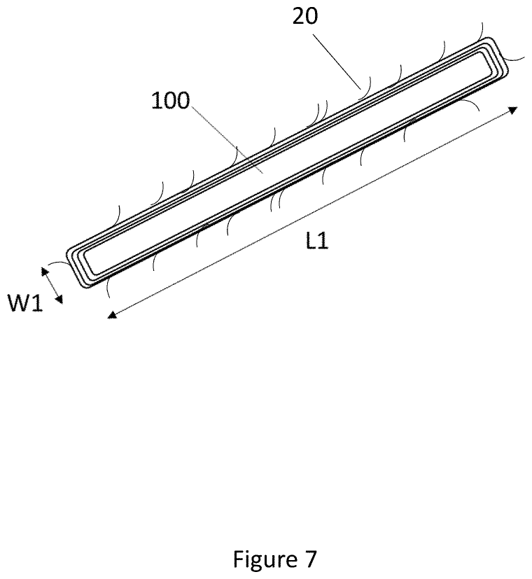

FIG. 7 is an illustration depicting a multilayered metal chalcogenide nanotube 100 having an outer layer having at least one sectioned portion 20 that extends along a direction away from the substantially planar sidewalls that extend along the greatest length L1 of the multilayered nanotube 100. The at least one sectioned portion 20 at the ends of the multi-layered nanotubes 100 extends away from the curvature of the multi-layered nanotube 100, and the at least one sectioned portion 20 is engaged to remaining section of the outer layer of the multilayered nanotube 20.

It is noted that the nanotubes 100 depicted in FIGS. 6 and 7 may be substituted for any of the nanotubes 100 for any of the embodiments, e.g., applications of the nanotubes 100 in composites including polymer including matrixes, applications of the nanotubes 100 in adhesives and applications of the nanotubes 100 lubricants, that are described herein. Additionally, the nanotubes 100 depicted in FIGS. 6 and 7 may be employed for at least one on the cylinders, e.g., multilayered cylinders, employed in the nanologs and applications for nanologs that are described herein.

In one embodiment, the multi-layered nanotubes and/or nanologs are of an metal chalcogenide composition having a molecular formula of MX₂, where M is a metallic element selected from the group consisting of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg) and combinations thereof, and X is a chalcogen element selected from the group consisting of sulfur (S), selenium (Se), tellurium (Te), oxygen (O) and combinations thereof. Two example compositions for the structures depicted in FIGS. 6 and 7 include MoS₂ and WS₂.

The core of the multi-layered nanotubes and/or nanologs having the sectioned outer layer may be hollow, solid, amorphous, or a combination of hollow, solid and amorphous portions.

The inorganic material having the metal chalcogenide composition and the nanotube like geometry with the sectioned outer layer is not limited on only single layer or double layered structures, as the inorganic material may have any number of layers. For example, the metal chalcogenide composition may be layered to include 5 layers to 100 layers of metal chalcogenide material that can exfoliate from the nanostructure. In another embodiment, the metal chalcogenide composition may be layered to include 10 layers to 50 layers of metal chalcogenide material that can exfoliate from the nanostructure. In yet another embodiment, the metal chalcogenide composition may be layered to include 15 layers to 20 layers of metal chalcogenide material that can exfoliate from the particle. These structures are also referred to in the art as being “nested layer structures”.

The multi-layered nanotubes 100 that include the at least one sectioned portion that is depicted in FIGS. 6 and 7 may be formed beginning with the multilayered nanotube like structures described above, e.g., described with reference to FIGS. 1-5. Beginning with a multi-layered nanotube structure of metal chalcogenide, e.g., tungsten disulfide (WS₂) or molybdenum disulfide (MoS₂) that does not include a sectioned outer layer, a force is applied to open up sections in the outer layer, which peels a portion of the outer layer from the curvature of the multi-layered nanotubes 100. The force may be applied using any means to apply a physical force to the particles, such as milling, e.g., dry and/or wet milting, sonification, ultrasonication, and combinations thereof. The time and force is dependent upon the degree of sectioning preferred in the outer layer.

The sectioned outer layer provides a charged surface for the nanoparticle. The charged surface that results from the sectioned outer layer facilitates grafting of functional groups onto the multi-layered nanotubes 100, which can be used to control rheology of dispersions and mixtures including the multi-layered nanotubes 100 having the sectioned outer layer. For example, the functionalized sectioned outer layer may allow for the multi-layered nanotubes 100 to be dispersed more easily than multi-layered nanotube structures that do not include the sectioned outer layer. Further, the sectioned outer layer can allow for layers of metal chalcogenide to be exfoliated in response to lower pressures and forces in lubrication of frictional surfaces, and repair of frictional surfaces in comparison to multi-layered nanotube structures that do not include the sectioned outer layer.

For both structural polymer applications and adhesive applications, the incorporation of the dispersed phase of the metal chalcogenide nanotubes within the polymeric matrix can simultaneously increase both the elongation and toughness of polymer when compared to the same polymeric base composition not including a dispersed phase of metal chalcogenide nanotubes. Thus, fracture toughness, modulus, shear stress of toughened polymers increases by 50% to 100% comparing to neat material. In one embodiments, the method includes functionalizing metal chalcogenide nanotubes to provide a non-agglomerated mixture; and mixing the non-agglomerated mixture of metal chalcogenide nanotubes within a polymer material, such as an epoxy, to provide mixture of uniformly dispersed metal chalcogenide nanotubes within the polymeric matrix material. The mixture of uniformly dispersed metal chalcogenide nanotubes is the epoxy based material is then applied to an adhesion surface and cured.

In addition to the polymeric composite and adhesive compositions and materials described above, the nanotubes, e.g., as depicted in FIGS. 1-3, 6 and 7, and nanologs that have been described herein, can be applied to lubricants. For example, the lubricant may include a fluid medium; and at least one intercalation compound of a metal chalcogenide having molecular formula MX₂, where M is a metallic element selected from the group consisting of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg) and combinations thereof, and X is a chalcogen element selected from the group consisting of sulfur (S), selenium (Se), tellurium (Te), oxygen (O) and combinations thereof. The intercalation compound has a multi-layered layered nanotube and/or nanolog structure.

In some embodiments, the outer layer of the multi-layered nanotube and/or nanolog structure comprises at least one sectioned portion. The at least one sectioned portion extends along a direction away from the substantially planar sidewalls that extend along the greatest length of the multilayered nanotube or multilayered nanolog. The at least one sectioned portion at the ends of the multi-layered cylinders extend away from the curvature of the multi-layered nanotube and/or nanolog, and the at least one sectioned portion engaged to remaining section of the outer layer of the multilayered nanotube or multilayered nanolog.

The term “without a sectioned outer layer” denotes that the majority of nanotube and/or nanolog nanoparticles that are in suspension within the lubricant can be those having a non-sectioned outer layer prior to contact with a friction surface, such as the nanotubes depicted in FIG. 1. The term “with a sectioned outer layer” denotes that the majority of nanotube and/or nanolog nanoparticles that are in suspension within the lubricant can be those having a sectioned outer layer prior to contact with a friction surface, such as the nanotubes depicted in FIGS. 6 and 7. The nanotubes and nanologs employed in the polymer composites, adhesives and lubricants that are described herein may employ a combination of tube like geometry particles having a sectioned outer layer and tube like geometry particles without a sectioned outer layer. In some examples, the portion of nanostructures, e.g., nanotubes and/or nanologs, with a sectioned layer relative to the totality, i.e., the combination of both sectioned outer layer and non-sectioned outer layer nanostructures, e.g., nanotubes and/or nanologs, that are employed in the composites, adhesives and lubricants described herein may be equal to 1%, 2%, 5%, 10%, 20%, 30%, 40%, 50%, 60%, 70%, 80%, 90%, 95% and 99%, by weight. Further, any range of values for the portion of nanostructures having a sectioned outer layer to the totality of nanostructures, i.e., nanotubes and/or nanologs, being employed in the composites, adhesives and lubricants is possible using one of the aforementioned examples as the minimum value of the range, and one of the aforementioned examples as a maximum value of the range.

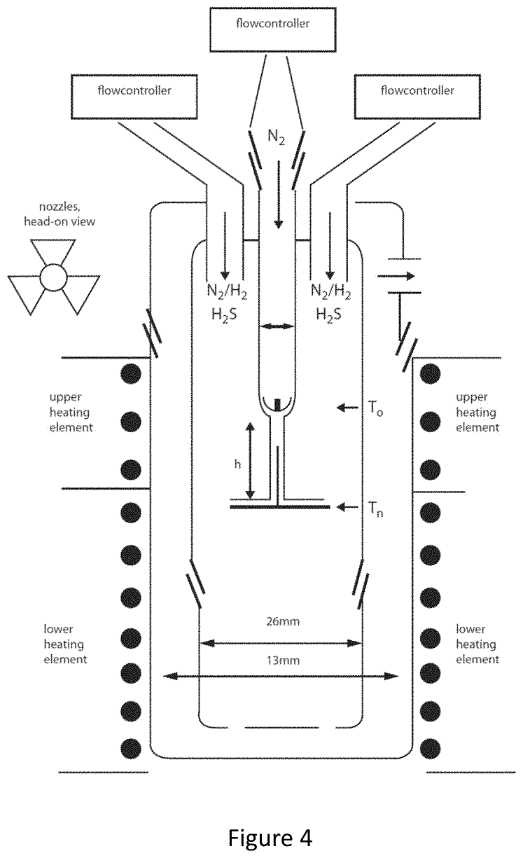

The nanotubes and nanologs employed in the lubricant may be formed using any of the aforementioned methodologies, such as those described above with reference to FIGS. 4 and 5.

The fluid medium of the lubricant may be water based, oil based or can be an emulsion of water and oil. In one example, the fluid medium is an oil selected from Group I, II, III, IV and V, as designated by the American Petroleum Institute (API). Group I base oils are classified as less than 90 percent saturates, greater than 0.03 percent sulfur (S) with a viscosity-index range of 80 to 120. In some embodiments, the temperature range for these oils is from 32 degrees F. to 150 degrees F. Group I base oils can be manufactured by solvent extraction, solvent or catalytic dewaxing, and hydro-finishing processes. Common Group I base oil may include 150SN (solvent neutral), 500SN, and 150BS (brightstock). Group I base oils are typically mineral oils.

Group II base oils are defined as being more than 90 percent saturates, less than 0.03 percent sulfur and with a viscosity index of 80 to 120. Group II base oils can be often manufactured by hydrocracking. Since all the hydrocarbon molecules of these oils are saturated, Group II base oils have better antioxidation properties than Group I base oils. Group II base oils are also typically mineral oils.

Group III base oils are defined as being greater than 90 percent saturates, less than 0.03 percent sulfur and have a viscosity index above 120. These oils are refined even more than Group II base oils and generally are hydrocracked with a higher pressure and heat than Group II. The processing for forming Group III base oils are typically longer than the processing for Group II base oils, and are designed to achieve a purer base oil. Although typically made from crude oil, Group III base oils are sometimes described as synthesized hydrocarbons. Group III base oils can be manufactured by processes, such as isohydromerization, and can be manufactured from base oil or slax wax from dewaxing process.

Group IV base oils are polyalphaolefins (PAOs). These synthetic base oils are made through a process called synthesizing. More specifically, in some embodiments, the process may begin with oligomerisation of alpha olefins and a catalyst. Oligomerization is followed by distillation. The oligomerization and distillation steps may include steam cracking hydrocarbons to produce ultra high-purity ethylene, ethylene oligomerization to develop 1-decene and 1-dodecene, and decene or dodecene oligomerization to form a mixture of dimers, trimers, tetramers and higher oligomers. Distillation is followed by hydrogenation including hydrogen and a catalyst. Group IV base oils such as polyalphaolefins (PAOs) are suitable for a broader temperature range that Group I, II and III base oils, and are applicable for use in extreme cold conditions and high heat applications. Group IV base oils typically have a viscosity index of at least 140.

Group V base oils are classified as all other base oils, including silicone, phosphate ester, polyalkylene glycol (PAG), polyolester, biolubes, etc. These base oils are at times mixed with other base stocks, such as the aforementioned Group I, II, III and IV base oils. An example would be polyalphaolefin (PAO) that is mixed with a polyolester. Esters are common Group V base oils used in different lubricant formulations to improve the properties of the existing base oil. In some embodiments, ester oils can take more abuse at higher temperatures and will provide superior detergency compared to a polyalphaolefin (PAO) synthetic base oil, which in turn increases the hours of use. Examples of synthetic oils include olefins, isomerized olefins, synthetic esters, phosphate esters, silicate esters, polyalkylene glycols, etc.

In another embodiment, the fluid component, i.e., fluid medium, of the lubricant can be a biolubricant. Biolubricants can primarily be triglyceride esters derived from plants and animals. Examples of biolubricants that are suitable for the fluid component that is mixed with the intercalation compound of the metal chalcogenide having the molecular formula MX₂ include lanolin, whale oil, canola oil, castor oil, palm oil, sunflower seed oil, rapeseed oil and tall oil.

In one example, the fluid medium is a water based fluid. The water based fluid may be a fluid or gel that is made from a base of water and typically a cellulose or glycerin solution. A water based fluid may be used on its own or in combination with other materials described herein to provide the fluid medium of the lubricant. It is noted that the above compositions provided for the fluid medium of the lubricants disclosed herein are provided for illustrative purposes only, and are not intended to limit the present disclosure. Other compositions and fluids have also been contemplated for use with the at least one intercalation compound of the metal chalcogenide having molecular formula MX₂.

The surface of the inorganic nanotube and/or nanolog (with and/or without a sectioned outer layer) partilces having the molecular formula MX₂ is functionalized or modified in order to obtain their homogeneous dispersion in the fluid medium of the lubricant, prevent particles agglomeration and settling. A “dispersion” is a system of two phases, in which discrete particles, i.e., primary particles, such as the inorganic nanotube and/or nanolog (with and/or without a sectioned outer layer) particles having the molecular formula MX₂, provide a first phase that are distributed in the other second phase, in which the second phase is a substantially continuous phase (dispersion medium) differing from the dispersed phase in composition. Dispersions are homogeneous when the ratio of solute, i.e., primary particles, such as the inorganic nanotube and/or nanolog (with and/or without a sectioned outer layer) particles having the molecular formula MX₂, to solvent, i.e., fluid medium, remains the same throughout the solution even if homogenized with multiple sources, and stable because, the solute will not settle out. This type of mixture, which is provided by the methods and compositions disclosed herein, is very stable, i.e., its particles do not settle, or separate. As used herein, “agglomeration” means an association of primary particles, which can range from relatively weak (based upon, for example, charge or polarity) to relatively strong (based upon, for example, chemical bonding). When the primary particles, i.e., inorganic nanotube and/or nanolog (with and/or without a sectioned outer layer) partilces having the molecular formula MX₂, agglomerate they can fall, i.e., settle, from suspension. The methods and compositions that are provided herein provide dispersions that do not agglomerate or settle for a period of time that may be as great as 5 years, e.g., as great as 3 years. The dispersions are stabilized from agglomeration or settling by the functionalization agents that is described below, and the particle size that is provided by mechanical downgrading, such as particle size reductions provided by milling and/or high pressure homogenization and/or high shear mixing and/or ultrasonic mixing and/or a combination thereof.

The surface of the inorganic nanotube and/or nanolog (with and/or without a sectioned outer layer) particles having the molecular formula MX₂ may be functionalized or modified by forming an adsorption-solvate protective layer on the particle surfaces, i.e., surface of the inorganic nanotube and/or nanolog (with and/or without a sectioned outer layer) particles having the molecular formula MX₂, and preventing the close approach and coagulation of particles under the action of short-range forces of molecular attraction. The close approach of particles may be impeded by the disjoining pressure of the liquid dispersion medium, which is solvated by molecules or ions of the stabilizer in the adsorption layer, by electrostatic repulsion of like-charged ions adsorbed on the particle surfaces, or by enhanced structural viscosity of the surface protective layer, which can also be referred to as being a structural-mechanical barrier.

Surface functionalization for the surface of the inorganic nanotube and/or nanolog (with and/or without a sectioned outer layer) partilces having the molecular formula MX₂ may be provided by functionalizing agents that include silanes, thiols, ionic, anionic, cationic, nonionic surfactants, amine based dispersant and surfactants, succinimide groups, fatty acids, acrylic polymers, copolymers, polymers, monomers and combinations thereof.

In some embodiments, the functionalizing agents can be described as comprising a headgroup (a part that interacts primarily with the surface of the nanotube and/or nanolog (with and/or without a sectioned outer layer) particles having the molecular formula MX₂) and a tailgroup (a part that interacts with the solvent, i.e., fluid medium). For example, the headgroup of the functionalizing agent may interact with the sectioned portion 20 of the outer layer of the nanotube and/or nanolog that is depicted in FIG. 20. Useful headgroups include those that comprise alkoxy, hydroxyl, halo, thiol, silanol, amino, ammonium, phosphate, phosphonate, phosphonic acid, phosphinate, phosphinic acid, phosphine oxide, sulfate, sulfonate, sulfonic acid, sulfinate, carboxylate, carboxylic acid, carbonate, boronate, stannate, hydroxamic acid, succinimide, dithiophosphate, and/or like moieties. Multiple headgroups can extend from the same tailgroup, as in the case of 2-dodecylsuccinic acid and (1-aminooctyl) phosphonic acid. Useful hydrophobic and/or hydrophilic tailgroups include those that comprise single or multiple alkyl, aryl, cycloalkyl, cycloalkenyl, haloalkyl, oligo-ethylene glycol, oligo-ethyleneimine, dialkyl ether, dialkyl thioether, aminoalkyl, and/or like moieties. Multiple tailgroups can extend from the same headgroup, as in the case of trioctylphosphine oxide.

Examples of silanes that are suitable for use as functionalizing agents with the nanotube and/or nanolog (with and/or without a sectioned outer layer) particles having the molecular formula MX₂ and the fluid medium of the present disclosure include organosilanes including, e.g., alkylchlorosilanes, alkoxysilanes, e.g., methyltrimethoxysilane, methyltriethoxysilane, ethyltrimethoxysilane, ethyltriethoxysilane, n-propyltrimethoxysilane, n-propyltriethoxysilane, i-propyltrimethoxysilane, ipropyltriethoxysilane, butyltrimethoxysilane, butyltriethoxysilane, hexyltrimethoxysilane, octyltrimethoxysilane, 3-mercaptopropyltrimethoxysilane, n-octyltriethoxysilane, phenyltriethoxysilane, polytriethoxysilane, vinyltrimethoxysilane, vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri(t-butoxy)silane, vinyltris(isobutoxy)silane, vinyltris (isopropenoxy) silane, and vinyltris (2-methoxyethoxy) silane; trialkoxyarylsilanes; isooctyltrimethoxy-silane; N-(3-triethoxysilylpropy-1) methoxyethoxyethoxy ethyl carbamate; N-(3-triethoxysilylpropyl) methoxyethoxyethoxyethyl carbamate; silane functional (meth)acrylates including, e.g., 3-(methacryloyloxy)propyltrimethoxysilane, 3-acryloyloxypropyltrimethoxysilane, 3-(methacryloyloxy)propyltriethoxysi-lane, 3-(methacryloyloxy)propylmethyldimethoxysilane, 3-(acryloyloxypropyl) methyldimethoxysilane, 3-(methacryloyloxy) propyldime-thylethoxysilane,

3-(methacryloyloxy) methyltriethoxysilane, 3-(methacryloyloxy) methyltrimethoxysilane, 3-(methacryloyloxy) propyldimet-hylethoxysilane, 3-methacryloyloxy) propenyltrimethoxysilane, and 3-(methacryloyloxy) propyltrimethoxysilane; polydialkylsiloxanes including, e.g., polydimethylsiloxane, arylsilanes including, e.g., substituted and unsubstituted arylsilanes, alkylsilanes including, e.g., substituted and unsubstituted alkyl silanes including, e.g., methoxy and hydroxy substituted alkyl silanes, and combinations thereof.

Examples of amines that are suitable for use as functionalizing agents with the nanotube and/or nanolog (with and/or without a sectioned outer layer) partilces having the molecular formula MX₂ and the fluid medium of the present disclosure include alkylamines including, e.g., octylamine, oleylamine, decylamine, dodecylamine, octadecylamine, monopolyethylene glycol amines, and combinations thereof.

Useful organic acid functionalizing agents include, e.g., oxyacids of carbon (e.g., carboxylic acid), sulfur and phosphorus, and combinations thereof.

Representative examples of polar functionalizing agents having carboxylic acid functionality include CH₃O (CH₂CH₂O)₂C—H₂COOH (hereafter MEEAA) and 2-(2-methoxyethoxy) acetic acid having the chemical structure CH₃OCH₂CH₂OCH₂COOH hereafter MEAA) and mono (polyethylene glycol) succinate in either acid or salt forms.

Representative examples of non-polar functionalizing agents having carboxylic acid functionality include octanoic acid, dodecanoic acid and oleic acid.

Examples of suitable phosphorus containing acids that are suitable as functionalizing agents include phosphonic acids including, e.g., octylphosphonic acid, laurylphosphonic acid, decylphosphonic acid, dodecylphosphonic acid, octadecylphosphonic acid, and monopolyethylene glycol phosphonate in either acid or salt forms.

Examples of other useful functionalizing agents include acrylic acid, methacrylic acid, beta-carboxyethyl acrylate, mono-2-(methacryloyloxyethyl) succinate, and combinations thereof. A useful surface modifying agent is mono (methacryloyloxypolyethyleneglycol-) succinate.

Examples of suitable alcohols for functionalizing agents include, e.g., aliphatic alcohols including, e.g., octadecyl, dodecyl, lauryl and furfuryl alcohol, alicyclic alcohols including, e.g., cyclohexanol, and aromatic alcohols including, e.g., phenol and benzyl alcohol, and combinations thereof.

In some embodiments, surface functionalization of the inorganic nanotubes and/or nanologs, such as metal chalcogenide nanotubes and/or nanologs, e.g., tungsten disulfide (WS₂) and/or molybdenum disulfide (MoS₂), may include the application of a compound comprising a at least one dithiophosphate group to the inorganic nanotubes and/or nanologs. The compound comprising a dithiophosphate group may be referred to as “dithiophosphate”. In some examples, the dithiophosphate can be selected from the ammonium dithiophosphates, the amine dithiophosphates, the ester dithiophosphates and the metal dithiophosphates, alone or in a mixture.

In an embodiment of the invention, the dithiophosphate is selected from the ammonium dithiophosphates of formula (I):

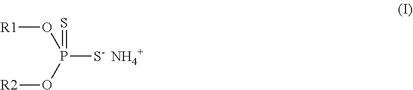

in which R1 and R2 represent, independently of one another, a hydrocarbon-containing group, optionally substituted, comprising from 1 to 30 carbon atoms.

In a one embodiment, R1 and R2 represent, independently of one another, a hydrocarbon-containing group, optionally substituted, comprising from 2 to 24 carbon atoms, and in some embodiments from 3 to 18 carbon atoms. In yet other embodiments, the R1 and R2 represent, independently from one another, a hydrocarbon group comprising from 5 to 12 carbon atoms. In another embodiment, R1 and R2 represent, independently of one another, an unsubstituted hydrocarbon-containing group, and said hydrocarbon-containing group can be an alkyl, alkenyl, alkynyl, phenyl or benzyl group. In another embodiment, R1 and R2 represent, independently of one another, a linear or branched alkyl hydrocarbon-containing group, more preferentially a linear alkyl hydrocarbon-containing group. In yet another embodiment, R1 and R2 represent, independently of one another, a hydrocarbon-containing group optionally substituted by at least one oxygen, nitrogen, sulphur and/or phosphorus atom, preferably by at least one oxygen atom. As examples of ammonium dithiophosphate, the ammonium dimethyldithiophosphates, the ammonium diethyldithiophosphates and the ammonium dibutyldithiophosphates can be mentioned.

In another embodiment, the dithiophosphate is selected from the amine dithiophosphates of general formula (II):

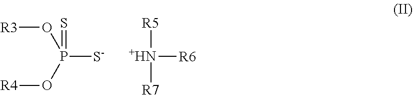

in which: R3 and R4 represent, independently of one another, a hydrocarbon-containing group, optionally substituted, comprising from 1 to 30 carbon atoms. R5, R6 and R7 represent, independently of one another, a hydrogen atom or a hydrocarbon-containing group with 1 to 30 carbon atoms, it being understood that at least one of the R5, R6 and R7 groups does not represent a hydrogen atom.

In yet another embodiment, R3 and R4 represent, independently of one another, a hydrocarbon-containing group, optionally substituted, comprising from 2 to 24 carbon atoms. In yet another embodiment, R3 and R4 represent, independently of one another, from 3 to 18 carbon atoms, and in some examples from 5 to 12 carbon atoms. In another embodiment, R3 and R4 represent, independently of one another, an unsubstituted hydrocarbon-containing group, and said hydrocarbon-containing group can be an alkyl, alkenyl, alkynyl, phenyl or benzyl group. In an even further embodiment, R3 and R4 represent, independently of one another, a linear or branched alkyl hydrocarbon-containing group, more preferentially a linear alkyl hydrocarbon-containing group. In another embodiment, R3 and R4 represent, independently of one another, a hydrocarbon-containing group optionally substituted by at least one oxygen, nitrogen, sulphur and/or phosphorus atom, preferably by at least one oxygen atom. In yet another embodiment, R5, R6 and R7 represent, independently of one another, a hydrocarbon-containing group comprising from 2 to 24 carbon atoms, more preferentially from 3 to 18 carbon atoms, advantageously from 5 to 12 carbon atoms.

In yet another embodiment, the dithiophosphate is selected from the ester dithiophosphates of general formula (III):

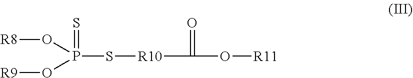

in which:

R8 and R9 represent, independently of one another, a hydrocarbon-containing group, optionally substituted, comprising from 1 to 30 carbon atoms, R10 and R11 represent, independently of one another, a hydrocarbon-containing group comprising from 1 to 18 carbon atoms.

In one embodiment, R8 and R9 represent, independently of one another, a hydrocarbon-containing group, optionally substituted, comprising from 2 to 24 carbon atoms, in one example from 3 to 18 carbon atoms, and in yet another example from 5 to 12 carbon atoms. In another embodiment, R8 and R9 represent, independently of one another, an unsubstituted hydrocarbon-containing group, and said hydrocarbon-containing group can be an alkyl, alkenyl, alkynyl, phenyl or benzyl group. In another embodiment, R8 and R9 represent, independently of one another, a linear or branched alkyl hydrocarbon-containing group, more preferentially a linear alkyl hydrocarbon-containing group.

In another embodiment, R8 and R9 represent, independently of one another, a hydrocarbon-containing group optionally substituted by at least one oxygen, nitrogen, sulphur and/or phosphorus atom, preferably by at least one oxygen atom. In another preferred embodiment of the invention, R8 and R9 represent, independently of one another, a hydrocarbon-containing group comprising from 2 to 6 carbon atoms. In another embodiment, R10 and R11 represent, independently of one another, a hydrocarbon-containing group comprising from 2 to 6 carbon atoms.

In another embodiment, the dithiophosphate is selected from the metal dithiophosphates of general formula (IV):

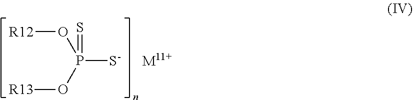

in which:

R12 represents a linear or branched, saturated or unsaturated, substituted or unsubstituted alkyl group comprising from 1 to 30 carbon atoms; R13 represents a linear or branched, saturated or unsaturated, substituted or unsubstituted alkyl group comprising from 1 to 30 carbon atoms; M represents a metal cation, preferably a Zn²⁺ cation; n represents the valency of the metal cation.

In another embodiment, the metal is selected from the group constituted by zinc, aluminium, copper, iron, mercury, silver, cadmium, tin, lead, antimony, bismuth, thallium, chromium, molybdenum, cobalt, nickel, tungsten, sodium, calcium, magnesium, manganese and arsenic. Some examples of metals suitable for this composition include zinc, molybdenum, antimony, preferably zinc and molybdenum. In one example, the metal is zinc. Mixtures of metals can be used. The metal dithiophosphates can be neutral, as exemplified in formula (IV), or basic when a stoichiometric excess of metal is present.

In one embodiment, R12 and R13 represent, independently of one another, a hydrocarbon-containing group, optionally substituted, comprising from 2 to 24 carbon atoms, more preferentially from 3 to 18 carbon atoms, advantageously from 5 to 12 carbon atoms. In another preferred embodiment of the invention, R12 and R13 represent, independently of one another, an unsubstituted hydrocarbon-containing group, and said hydrocarbon-containing group can be an alkyl, alkenyl, alkynyl, phenyl or benzyl group. In another preferred embodiment of the invention, R12 and R13 represent, independently of one another, a linear or branched alkyl hydrocarbon-containing group, more preferentially a linear alkyl hydrocarbon-containing group. In another preferred embodiment of the invention, R12 and R13 represent, independently of one another, a hydrocarbon-containing group optionally substituted by at least one oxygen, nitrogen, sulphur and/or phosphorus atom, preferably by at least one oxygen atom.

Advantageously, the dithiophosphate according to the invention is a zinc dithiophosphate of formula (IV-a) or of formula (IV-b):

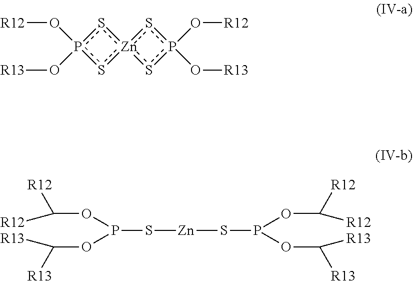

in which R12 and R13 are as defined above.

In another embodiment, the dispersant can be selected from the compounds comprising at least one succinimide group, the polyolefins, the olefin copolymers (OCP), the copolymers comprising at least one styrene unit, the polyacrylates or their derivatives. By derivatives, is meant any compound comprising at least one group or a polymer chain as defined above. Advantageously, the dispersant according to the invention is selected from the compounds comprising at least one succinimide group.

In one embodiment, the dispersant can be selected from the compounds comprising at least one substituted succinimide group or the compounds comprising at least two substituted succinimide groups, the succinimide groups being linked at their vertex bearing a nitrogen atom by a polyamine group. A substituted succinimide group is a succinimide group in which at least one of the carbon-containing vertices of which is substituted with a hydrocarbon-containing group comprising from 8 to 400 carbon atoms. In one embodiment, the dispersant is selected from the polyisobutylene succinimide-polyamines. The dispersant can be a substituted succinimide of formula (I) or a substituted succinimide of formula (II):

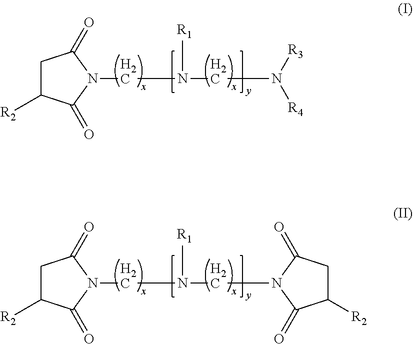

in which:

x represents an integer ranging from 1 to 10, preferably 2, 3, 4, 5 or 6;

y represents an integer ranging from 2 to 10;

R₁ represents a hydrogen atom, a linear or branched alkyl group comprising from 2 to 20 carbon atoms, a heteroalkyl group comprising from 2 to 20 carbon atoms and at least one heteroatom selected from the group formed by O, N and S, a hydroxyalkyl group comprising from 2 to 20 carbon atoms or a —(CH₂)ₓ—O—(CH₂)ₓ—OH group;

R₂ represents a linear or branched alkyl group comprising from 8 to 400 carbon atoms, preferably from 50 to 200 carbon atoms, an aryl group comprising from 8 to 400 carbon atoms, preferably from 50 to 200 carbon atoms, a linear or branched arylalkyl group comprising from 8 to 400 carbon atoms, preferably from 50 to 200 carbon atoms or a linear or branched alkylaryl group comprising from 8 to 400 carbon atoms, preferably from 50 to 200 carbon atoms; and

R₃ and R₄, identical or different, represent independently a hydrogen atom, a linear or branched alkyl group comprising from 1 to 25 carbon atoms, an alkoxy group comprising from 1 to 12 carbon atoms, an alkylene group comprising from 2 to 6 carbon atoms, a hydroxylated alkylene group comprising from 2 to 12 carbon atoms or an aminated alkylene group comprising from 2 to 12 carbon atoms.

The dispersant may be a substituted succinimide of formula (I) or a substituted succinimide of formula (II) in which R₂ represents a polyisobutylene group. The dispersant may be a substituted succinimide of formula (II) in which R₂ represents a polyisobutylene group. The dispersant may be a substituted succinimide of formula (II) in which:

R₁ represents a —(CH₂)ₓ—O—(CH₂)ₓ—OH group,

R₂ represents a polyisobutylene group,

x represents 2, and

y represents 5.

In some embodiments, the dispersant of succinimide has a weight-average molecular weight ranging from 2000 to 15000 Daltons, preferably ranging from 2500 to 10000 Daltons, advantageously from 3000 to 7000 Daltons. In some embodiments, the dispersant also has, moreover, a number-average molecular weight greater than or equal to 1000 Daltons, preferably ranging from 1000 to 5000 Daltons, in one example from 1800 to 3500 Daltons, and in yet another example from 1800 to 3000 Daltons. In one example, number-average molecular weight of the dispersant is assessed according to the standard ASTM D5296. The content by weight of dispersant having a weight-average molecular weight greater than or equal to 2000 Daltons ranges from 0.1 to 10%, preferably from 0.1 to 5%, advantageously from 0.1 to 3% with respect to the total weight of the lubricant composition.

In one embodiment, the content by weight of the compound comprising a dithiophosphate group and/or succinimide group ranges from 0.1 to 5% with respect to the total weight of the lubricant composition. In another embodiment, the content by weight of the compound comprising a dithiophosphate group and/or succinimide group ranges from 0.2 to 4% with respect to the total weight of the lubricant composition. In yet a further embodiment, the content by weight of the compound comprising a dithiophosphate group and/or succinimide group ranges from 0.5 to 2% with respect to the total weight of the lubricant composition.

In some embodiments, the functionalizing agents may be introduced to the inorganic nanotube and/or nanolog (with and/or without a sectioned outer layer) particles having the molecular formula MX₂ during their formation prior to having the opportunity to agglomerate or destabilize from solution. In other embodiments, agglomerates of the inorganic nanotube and/or nanolog (with and/or without a sectioned outer layer) particles having the molecular formula MX₂ are first mechanically broken down into their primary size, i.e., the size of the primary particles prior to agglomeration. The mechanical reduction of the agglomerates of the tube-like particles having the molecular formula MX₂ to their primary size may be referred to as milling.

In some embodiments, inorganic nanotube and/or nanolog (with and/or without a sectioned outer layer) particles can be mixed with other solid particles, which may be from 1 nm to 10 microns in size, such as carbon fullerenes, carbon nanotubes, graphite, 2H—MoS₂, 2H—WS₂, boron, Zn, Cu, silver, graphite, MgOH, carbon diamond or combinations of thereof.

In some embodiments, the milling process may begin with agglomerates having a particle size ranging from 5 microns to 20 microns. The particles size of the agglomerates may be reduced using a high-shear mixer, two or three roll mixers, homogenizers, bead mills, ultrasonic pulverizer and a combination thereof. A high-shear mixer disperses, or transports, one phase or ingredient (liquid, solid, gas) into a main continuous phase (liquid), with which it would normally be immiscible. A rotor or impellor, together with a stationary component known as a stator, or an array of rotors and stators, is used either in a tank containing the solution to be mixed, or in a pipe through which the solution passes, to create shear. In some embodiments, the high shear mixer may be a batch high-shear mixers, an inline powder induction, a high-shear granulator, an ultra-high-shear inline mixers and a combinations thereof.

Other means for reducing the particle size of the agglomerates to the primary particle size of the inorganic nanotube and/or nanolog (with and/or without a sectioned outer layer) particles having the molecular formula MX₂ include an attritor, agitator, ball mill, bead mill, basket mill, colloid mill, high speed disperser, edge runner, jar mill, low speed paddle mixer, variable speed mixer, paste mixer, ribbon blender, pug mixer, nauta mixer, sand/perl mill, triple roll mill, two roll mill, planetary mixer, slow speed mixer, high speed mixer, twin shaft mixer, multi shaft mixer, sigma kneader, rotor-stator mixer, homogenizer/emulsifier, high shear mixer, conical blender, V-blender, double cone blender, suspended mixer and combinations thereof. The particle size of the agglomerates may also be reduced using a sonicator. The mixing may be performed at room temperature or at an elevated temperature. The reduction of the size of agglomerates by milling is distinguished from the milling of the nanoparticles themselves to provide that the nanoparticles have dimensions within the nanoscale realm.

In some embodiments, the fluid medium for the lubricant is mixed with the inorganic nanotube and/or nanolog (with and/or without a sectioned outer layer) particles having the molecular formula MX₂ during the milling step in which the agglomerates of the inorganic nanotube and/or nanolog (with and/or without a sectioned outer layer) particles having the molecular formula MX₂ are mechanically broken down into their primary size. The inorganic nanotube and/or nanolog (with and/or without a sectioned outer layer) particles having the molecular formula MX₂ may be mixed with the fluid medium in an amount ranging from 0.1% to 60% by volume. In another embodiment, the inorganic nanotube and/or nanolog (with and/or without a sectioned outer layer) particles having the molecular formula MX₂ may be mixed with the fluid medium in an amount ranging from 0.5% to 40% by volume. In yet another embodiment, the inorganic nanotube and/or nanolog (with and/or without a sectioned outer layer) particles having the molecular formula MX₂ may be mixed with the fluid medium in an amount ranging from 0.5% to 20% by volume.

In some embodiments, the agglomerates of the inorganic nanotube and/or nanolog (with and/or without a sectioned outer layer) particles having the molecular formula MX₂ is reduced during the milling step to a diameter ranging from 1 nm to 150 nm, and a length that ranges from 1 nm to 20 cm, for tube like geometries. In another embodiment, the agglomerates of the inorganic nanotube and/or nanolog (with and/or without a sectioned outer layer) particles having the molecular formula MX₂ is reduced during the milling step to a diameter ranging from 5 nm to 125 nm, and a length that ranges from 5 nm to 15 cm, for tube like geometries. In yet another embodiment, the inorganic nanotube and/or nanolog (with and/or without a sectioned outer layer) particles having the molecular formula MX₂ is reduced during the milling step to a diameter ranging from 10 nm to 100 nm, and a length that ranges from 100 nm to 10 cm, for tube-like geometries. Following milling, the particles having the inorganic tube-like geometry may have a diameter and length that is any value within the above ranges. It is noted that the above dimensions are provided for illustrative purposes only and are not intended to limit the present disclosure.

In some embodiments, once the agglomerates of the inorganic nanotube and/or nanolog (with and/or without a sectioned outer layer) particles having the molecular formula MX₂ are broken down into their primary size, the functionalizing agent may be added to the mixture of the fluid medium and the inorganic nanoparticles having the molecular formula MX₂. The functionalizing agent may be added to the mixture in an amount ranging from 0.1 wt % to 50 wt. % of the inorganic nanotube and/or nanolog (with and/or without a sectioned outer layer) particles.

The functionalizing agent applied to the mixture of the fluid medium and the inorganic nanotube and/or nanolog (with and/or without a sectioned outer layer) particles having the molecular formula MX₂ provide dispersions that do not agglomerate or settle for a period of time that may range from 3 hours to 5 years. In another embodiment, the functionalizing agent applied to the mixture of the fluid medium and the inorganic nanotube and/or nanolog (with and/or without a sectioned outer layer) particles having the molecular formula MX₂ provide dispersions that do not agglomerate or settle for a period of time that may range from 5 hours to 3 years. In yet another embodiment, the functionalizing agent applied to the mixture of the fluid medium and the inorganic nanotube and/or nanolog (with and/or without a sectioned outer layer) particles having the molecular formula MX₂ provide dispersions that do not agglomerate or settle for a period of time that may range from 24 hours to 1 year.

In one embodiment, the lubricant further includes an additive for antiwear performance, extreme pressure performance, anticorrosion performance, rust inhibiting performance, antifoam, viscosity modifying, friction modifying additives. The extreme pressure and antiwear additives may be selected from at least one of organophosphorus, organophosphorus sulfur, organosulphur, chlorine, sulfur-phosphorus-boron compounds and combinations thereof.

While the claimed methods and structures has been particularly shown and described with respect to preferred embodiments thereof, it will be understood by those skilled in the art that the foregoing and other changes in form and details may be made therein without departing from the spirit and scope of the presently claimed methods and structures.

1. A composite comprising:
a dispersed phase of an inorganic nanotube material of the metal chalcogenide has a molecular formula MX₂, where M is a metallic element selected from the group consisting of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Jr), platinum (Pt), gold (Au), mercury (Hg) and combinations thereof, and X is a chalcogen element selected from the group consisting of sulfur (S), selenium (Se), tellurium (Te), oxygen (O) and combinations thereof, wherein the inorganic nanotube material of the metal chalcogenide having the molecular formula MX₂ is uniformly present in a polymer matrix in an amount of greater than 0.1 wt %.

2. The composite of claim 1, wherein the polymer matrix has a composition selected from the group consisting of a fluoropolymer, a urethane polymer, a sulfonic polymer and combinations thereof.

3. The composite of claim 1, wherein the matrix is an epoxy based adhesive, an acrylic based adhesive or a combination thereof.

4. The composite of claim 1, wherein the inorganic nanotube material has an aspect ratio ranging from 100:1 to 150,000:1.

5. The composite of claim 1, wherein the inorganic nanotube material are nested layer structures.

6. The composite of claim 1, wherein the inorganic nanotube material has a hollow core.

7. The composite of claim 1, wherein the inorganic nanotube material is tungsten disulfide (WS₂) nanotubes having a solid core of WO₃₋ₓ (0≤x≤0.3).

8. A method of forming nanotubes comprising:
positioning a solid precursor containing a metal chalcogenide and oxygen on a reactor floor that is not permeable to gas in a reaction setup equipped with a reactor;
furnace heating the solid precursor in a reaction atmosphere comprising of hydrogen (H₂), hydrogen sulfide (H₂S) and nitrogen (N₂); and
maintaining a reaction atmosphere from 1 hour to 4 hours, wherein during the reaction period metal chalcogenide containing nanotubes are formed from the solid precursor having a diameter ranging from 10 nm to 500 nm, and a length up to 20 microns long.

9. The method of claim 8, wherein an entirety of the reactions from heating the solid precursor to maintaining the reaction atmosphere to provide the chalcogenide containing nanotubes is in a single reaction chamber.

10. The method of claim 8, wherein the precursor powder is placed in a quartz crucible.

11. The method of claim 8, wherein the solid precursor is a tungsten oxide precursor selected from the group consisting of WO₃, W_{O3-x} (0≤x≤0.3), ammonium paratungstate, ammonium metatungstate and combinations thereof.

12. The method of claim 8, wherein the reaction atmosphere is passed through the reactor in a flow direction from into the furnace to out of the furnace at a directional flow rate ranging from 10 sccm to 100,000 sccm.

13. The method of claim 8, wherein the metal chalcogenide containing nanotubes are tungsten disulphide nanotubes that are solid core.

14. The method of claim 8, wherein the metal chalcogenide containing nanotubes are tungsten disulphide nanotubes that are hollow core.

15. A method of forming nanotubes comprising:
positioning a solid precursor containing a metal chalcogenide and oxygen on a reactor floor that is not permeable to gas in a reaction setup equipped with reactor and furnace;
heating the furnace including the solid precursor to a temperature to ranging from 700° C. to 950° C. in an inert atmosphere;
exchanging the inert atmosphere with a reaction atmosphere that is a gas selected from the group consisting of hydrogen, hydrogen sulfide (H₂S) and nitrogen (N₂); and
maintaining a reaction atmosphere and the inert atmosphere for a reaction period ranging from 1 hour to 4 hours, wherein during the reaction period metal chalcogenide nanotubes are formed from the solid precursor.

16. The method of claim 15, wherein the metal chalcogenide nanotubes are tungsten disulphide or molybdenum disulfide having a diameter ranging from 10 nm to 500 nm, and a length up to 20 microns long.

17. The method of claim 15, wherein the solid precursor is a tungsten oxide precursor selected from the group consisting of WO₃, W_{O3-x} (0≤x≤0.3), ammonium paratungstate, ammonium metatungstate and combinations thereof.

18. A composite comprising:
a dispersed phase of an inorganic nanolog material of the metal chalcogenide has a molecular formula MX₂, where M is a metallic element selected from the group consisting of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg) and combinations thereof, and X is a chalcogen element selected from the group consisting of sulfur (S), selenium (Se), tellurium (Te), oxygen (O) and combinations thereof, wherein the inorganic nanolog material of the metal chalcogenide having the molecular formula MX₂ is uniformly present in a polymer matrix in an amount of greater than 0.1 wt %.

19. The composite of claim 18, wherein the polymer matrix has a composition selected from the group consisting of a fluoropolymer, a urethane polymer, a sulfonic polymer and combinations thereof.

20. The composite of claim 18, wherein the matrix is an epoxy based adhesive, an acrylic based adhesive or a combination thereof.
